(19) United States
(12) Patent Application Publication
(10) Pub. No.: US 2025/0190900 A1
(43) Pub. Date: Jun. 12, 2025

(54) SYSTEMS AND METHODS FOR A RESOURCES BALANCING TOOL

(71) Applicant: Wells Fargo Bank, N.A., San Francisco, CA (US)

(72) Inventors: Christian Mande, San Francisco, CA (US); Frank Digangi, San Francisco, CA (US); Darren M. Goetz, Salinas, CA (US); Sarah Lesky, San Francisco, CA (US); Dennis E. Montenegro, Concord, CA (US)

(21) Appl. No.: 17/560,111

(22) Filed: Dec. 22, 2021

(51) Int. Cl. G06Q 10/0631; G07D 11/34

(52) U.S. Cl. CPC G06Q 10/06315; G06Q 10/06311; G06Q 10/06312; G07D 11/34

(57) ABSTRACT

Systems and methods for a resources balancing tool are provided. A method includes: coupling, by a governing institution computing system, to a plurality of resource tracking devices associated with a plurality resource repositories; monitoring, by the governing institution computing system, resource availability across the plurality of resource repositories based on information received from the plurality of resource tracking devices; predicting, by the governing institution computing system, a resource amount in a resource repository of the plurality of resource repositories based on the monitored resource availability across the plurality of resource repositories; determining, by the governing institution computing system, that the predicted resource amount in the resource repository satisfies a threshold; and transmitting, by the governing institution computing system, a message based on the predicted resource amount in the resource repository satisfying the threshold.

### TECHNICAL FIELD

The present disclosure relates to systems and methods for providing a balancing tool. In particular, the systems, methods, and apparatuses described herein relate to a resources balancing tool including a graphical user interface that can facilitate internally balancing resources across multiple networks and devices based on a variety of factors, such as resource availability.

### BACKGROUND

A governing institution (e.g., a service provider, a financial institution, etc.) manages resources across various networks (e.g., bank branches, retail store locations, separate locations of a branch such as a separate location containing pneumatic tubes, etc.). Each of the networks of the governing institution includes devices that may retrievably store resources (e.g., vaults, teller drawers, teller cash recyclers, automated teller machines, cassettes, point of sale devices, pre-staged lockers, drop bags of cash, etc.). The devices may be configured to store a particular resource (e.g., a particular denomination or type of bill) and/or mixed resources. The resources stored in each of the devices may be monitored (or tracked) manually and independently of each other. This type of tracking/monitoring may lead to identifying devices and/or networks with reduced resource availability. For example, independently tracking each of the devices may result in identifying missed resource recycling opportunities and recirculation opportunities. Further, current tracking systems may not specify the particular resource availability at certain devices and/or within certain networks. Better systems and methods are desired to integrate the devices and networks to improve resource management.

### SUMMARY

At least one arrangement relates to a computer-implemented method. The method incudes coupling, by a governing institution computing system, to a plurality of resource tracking devices of a plurality resource repositories; monitoring, by the governing institution computing system, resource availability across the plurality of resource repositories based on information received from the plurality of resource tracking devices; predicting, by the governing institution computing system, a resource amount in a resource repository of the plurality of resource repositories based on the monitored resource availability across the plurality of resource repositories; determining, by the governing institution computing system, that the predicted resource amount in the resource repository satisfies a threshold; and transmitting, by the governing institution computing system, a message comprising an action in response to the predicted resource amount in the resource repository satisfying the threshold.

Another arrangement relates to a system. The system includes a processing circuit comprising a processor and a memory coupled to the processor, the memory containing instructions therein that, when executed by the processor, cause the processing circuit to: receive resource information associated with a device; predict a future resource information using a trained machine learning model and the received resource information; determine that the received resource information satisfies a resource threshold; and, transmit a notification to a user device comprising an action.

Yet another arrangement relates to a computer-implemented method. The method includes: receiving, by a user device, a user credential; authorizing, by the user device, access to an application running on the user device in response to the user credential matching an authorized user credential; receiving, by the user device, instructions to display a graphical user interface subsequent to accessing the application, the graphical user interface displaying a resource availability across a plurality of resource repository devices; displaying, by the user device, the graphical user interface to the user using a display on the user device, the graphical user interface instructing the user to transport a resource to a resource repository device of the plurality of resource repository devices; acquiring, by the user device, information regarding the resource repository device subsequent to the instruction; and transmitting, by the user device, a notification to a governing institution computing system associated with the resource repository device based on the acquired information.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 illustrates a block diagram of a computing system for tracking and communicating resource availability, according to an example embodiment.

FIG. 2 illustrates a graphical user interface (GUI) illustrating resource availability of a device in a network, according to an example embodiment.

FIG. 3 illustrates a GUI illustrating particular user resources, according to an example embodiment.

FIG. 4 illustrates a GUI illustrating flagged devices on a user device, according to an example embodiment.

FIG. 5 illustrates a block diagram of an example system using supervised learning that may be used to determine future resource availability of device(s) and/or network(s), according to an example embodiment.

FIG. 6 illustrates a block diagram of a simplified neural network that may be used to determine future resource availability of device(s) and/or network(s), according to an example embodiment.

FIG. 7 illustrates a flow diagram of a method for tracking and communicating resource availability, according to an example embodiment.

FIG. 8 illustrates a GUI illustrating a dashboard displaying resource availability, according to an example embodiment.

### DETAILED DESCRIPTION

Referring generally to the Figures, systems and methods for tracking and communicating resource availability using a graphical user interface are disclosed, according to various embodiments herein. The systems and methods described herein operate in real time or near real time to internally balance devices and networks in a system to improve operational efficiency of the system. As described herein, the “resource” is a physical currency (e.g., cash, Euros, coins, etc.). Conventionally, resource management has focused on limits, such as resource limits of each device (e.g., a teller cash recycler (TCR) limit, an automated teller machine (ATM) limit, a cash drawer limit, etc.), resource limits of a network (e.g., a branch limit), and the like. Further, the devices and/or networks are conventionally audited and evaluated based on the ability of the individual device and/or individual network of staying within the limit. Accordingly, tracking resources has been limited to tracking the overall capacity of particular individual devices and networks, not with respect to particular resources (e.g., specific denominations) across a plurality of devices and networks.

As described herein, a computing system of a governing institution monitors resources across various devices and/or networks, communicates the monitored information to pertinent users (e.g., employees of the governing institution such as tellers, bank managers, branch managers, third parties relative to the governing institution, etc.), and selectively implements one or more actions to balance the resources of the devices and/or networks. For example, the computing system may transmit an instruction to a user device to be displayed to a pertinent user in real time or near real time instructing the pertinent user to move a determined amount of resources between devices (such as between ATMs, vaults, teller windows), locations of network, and/or some combination thereof.

The actions implemented may be configured to recirculate resources between different devices and/or networks. Recirculating the resources in a system beneficially minimizes the amount of resources that are moved into or out of a network/device by identifying, in real time or near real time, based on the monitored data, where to move the resource, how much of the resource should be moved, and/or characteristics of the resource to be moved to replenish (or restock) one or more devices in the network. These actions may minimize the waste of computational resources and administrative resources by automatically monitoring and determining resource recirculation opportunities via the governing institution computing system. Similarly, these actions may be configured to recycle resources within a device. Recycling resources within a device beneficially minimizes the quantities of resources that are moved into or out of a device by proactively predicting (or identifying) a supply and demand of each particular resource stored in a device. The actions may minimize the waste of computational resources and administrative resources by automatically determining resource recycling actions based on the usage predictions of each resource via the governing institution computing system. Moreover, monitoring the resources of devices/networks beneficially reduces operational costs of the governing institution. For example, the governing institution may reduce the fees associated with transporting resources (e.g., cash), securing resources, and more, by optimizing the cash stored in each device and/or network.

The systems and methods described herein provide many benefits over existing computing systems. For example, generating and implementing actions based on monitored data in real time or near real time from devices/networks reduces current or expected computational resources and traffic transmitted over one or more networks of the system. For example, proactively managing devices/networks in real time eliminates communication that may be transmitted in the event that one or more devices/networks is full and/or empty (e.g., in a critical state, non-operational). Accordingly, computational resources are conserved by preventing or reducing the traffic transmitted across the network/system relating to the device in the critical state (e.g., critical device) and/or the network (e.g., identifying the critical device, communicating how to restock and/or resupply the critical device, scheduling transportation of resources for the critical devices).

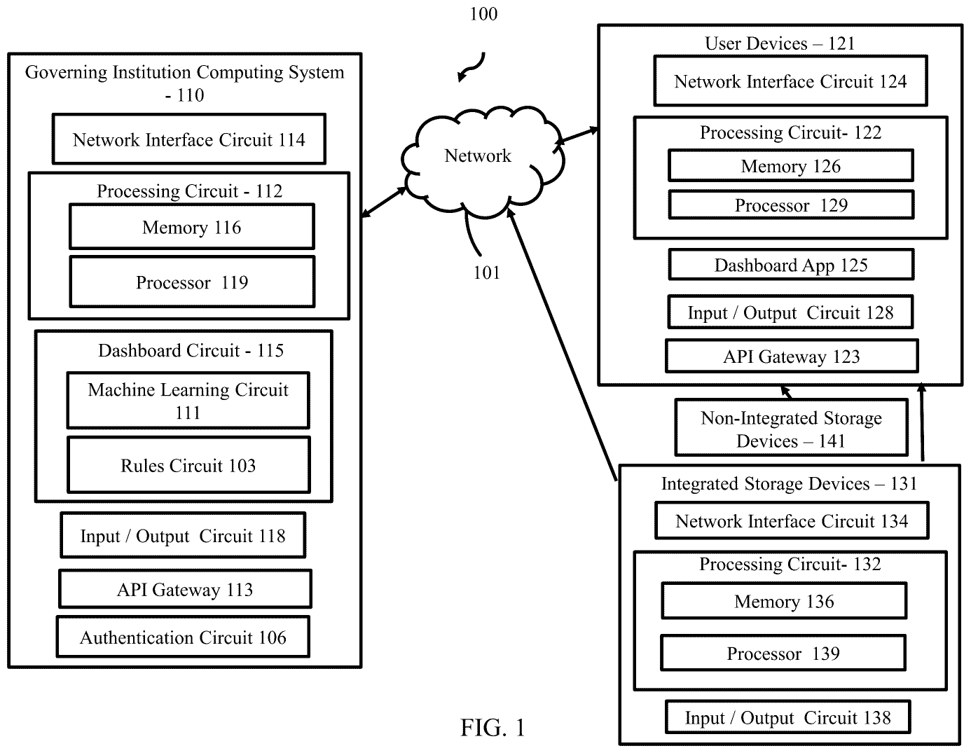

Referring now to FIG. 1, a block diagram of a computing system for tracking and communicating resource availability is shown, according to an example embodiment. The computing system 100 includes user device 121, non-integrated storage devices 141, integrated storage devices 131, and a governing institution computing system 110 associated with a governing institution. Components in FIG. 1 can be added, deleted, integrated, separated, and/or rearranged in various embodiments of the disclosed embodiments. The various systems and devices may be communicatively and operatively coupled through a network 101. Network 101 may permit the direct or indirect exchange of data, values, instructions, messages, and the like (represented by the arrows in FIG. 1). The network 101 may include one or more of the Internet, cellular network, Wi-Fi, Wi-max, a proprietary network, or any other type of wired or wireless network of a combination of wired or wireless networks.

A user may be a person who works for, directly or indirectly, the governing institution. For examples, users may include tellers, transporters, employees generally, contractors, administrators, vendors, and the like. As described herein, with reference to the authentication circuit 106, each user may be associated with a user account, user profile, user identification, and the like. The various permissions/authorizations/privileges of each user are associated with that user based on the privileges defined in their user account. One or more users may be responsible for authorizing other users to move/transport resources. For example, some users may be authorized to transport resources generally, some users may be authorized to transport resources up to a particular threshold amount, some users may be authorized to operate user devices 121, integrated storage devices 131, non-integrated storage devices 141, and the like.

Each user may own, use, control, or is otherwise associated with a user device 121. In the system 100, there may be a plurality of user devices 121. In one embodiment, the user associated with the user device 121 may manage, at least in part, resource availability across devices and/or networks. In some embodiments, users may be assigned to devices (e.g., a particular teller to a teller window) for a duration of time (e.g., a day, a week, a shift, etc.). For example, data fields in the user profile may reflect the user assigned to the user device.

The user device 121 is any type of electronic device that the user can use to communicate with the governing institution computing system 110. For example, the user device 121 may include watches (e.g., a smart watch), glasses (e.g., eye glasses, sunglasses, smart glasses, etc.), bracelets (e.g., a smart bracelet), standalone computers (e.g., laptop computers, desktop computers, etc.), and/or mobile devices (e.g., smart phones, personal digital assistants, tablet computers, etc.). In the example shown, the user device 121 is a mobile device and, particularly, a smartphone.

In some embodiments, each user device 121 is associated with a unique identifier (e.g., a user account, a device serial number, MAC address, etc.). In one embodiment, the unique identifier is a unique value specific to the user device, such as a device serial number, MAC address, etc. In another embodiment, the unique identifier is a generated unique value by the governing institution computing system 110. In this instance, the unique identifier may be determined by the governing institution computing system 110 by, e.g., incrementing a counter and assigning the value of the incremented counter to the user device 121 as the unique identifier; by utilizing a user identifier associated with a user account; etc. The governing institution computing system 110 may use the unique identifier associated with each user device to track the user device for record keeping purposes and/or security purposes. In some embodiments, the governing institution computing system 110 may receive information from the user device 121 (e.g., user credentials, user acknowledgement, etc.) to track the user device 121. As shown, the user device 121 includes a network interface circuit 124, a processing circuit 122, which may include a memory 126 coupled to a processor 129, a dashboard application 125, an input/output circuit 128, and an application programming interface (API) gateway 123.

The network interface circuit 124 is structured to receive communications from and provide communications to the governing institution computing system 110 and/or integrated storage device 131. As described in detail herein, the integrated storage device 131 is a resource repository storage device configured to store resources. In this regard, the network interface circuit 124 is structured to exchange data, communications, instructions, and the like with the governing institution computing system 110 and/or integrated storage device 131. For example, the network interface circuit 124 may transmit resource information including a timestamp regarding when resource information was received or last monitored, a characteristic of the resource (e.g., resource quantities such as a particular numbers of counted denominations), a device identifier of the device storing the resource (e.g., a serial number, a labeled number by an administrator), user information of a user currently assigned to the device, and the like, to the governing institution computing system 110. The network interface circuit 124 may receive, from the governing institution computing system 110, instructions to display and/or generate a graphical user interface.

The network interface circuit 124 of the user device 121 is structured or adapted for and configured to establish a communication link via the network 101 with the governing institution computing system 110 and/or integrated storage device 131. The network interface circuit 124 includes programming and/or hardware-based components that couple the user device 121 to the network 101. For example, the network interface circuit 124 may include any combination of a wireless network transceiver (e.g., a cellular modem, a Bluetooth transceiver, a Wi-Fi transceiver) and/or a wired network transceiver (e.g., an Ethernet transceiver). In some arrangements, the network interface circuit 124 includes the hardware and machine-readable media structured to support communication over multiple channels of data communication (e.g., wireless, Bluetooth, near-field communication, etc.). Further, in some arrangements, the network interface circuit 124 includes cryptography module(s) to establish a secure communication link (e.g., using the IPSec protocol or similar) in which data communicated over the link is encrypted and securely transmitted. In this regard, financial data (or other types of data) may be encrypted and transmitted to prevent or substantially prevent the threat of hacking or unwanted sharing of information. To support the features of the user device 121, the network interface circuit 124 provides a relatively high-speed link to the network 101, which may be any combination of a local area network (LAN), an intranet (e.g., a private banking or retailer network), the Internet, or any other suitable communications network, directly or through another interface.

The processing circuit 122 may include at least one memory 126 coupled to a processor 129. The memory 126 includes one or more memory devices (e.g., RAM, NVRAM, ROM, Flash Memory, hard disk storage) that store data and/or computer code for facilitating at least some of the various processes described herein. That is, in operation and use, the memory 126 stores at least portions of instructions and data for execution by the processor 129 to control the processing circuit 122. The memory 126 may be or include tangible, non-transient computer-readable volatile memory and/or non-volatile memory. The processor 129 may be implemented as one or more processors, application specific integrated circuits (ASICs), field programmable gate arrays (FPGAs), digital signal processors (DSPs), and/or other suitable electronic processing components.

The user device 121 is configured to run a variety of application programs and store associated data in a database of the memory 126, for instance. One such application run by the user device 121 (and executed via the processing circuit 122) may be a dashboard application 125. In the example shown, the dashboard application 125 is a downloaded and installed application that includes program logic (e.g., computer code, modules, etc.) stored in a system memory (or other storage location) of the user device 121. The dashboard application 125 is communicably coupled via the network interface circuit 124 over the network 101 to the governing institution computing system 110 and, particularly to the dashboard circuit 115 that may support at least certain processes and functionalities of the dashboard application 125. In this regard, the governing institution computing system 110 may provide the dashboard application 125 for download (e.g., via an app store) and at least partially support the features, functionalities, and capabilities of the dashboard application 125. During download and installation, and in some embodiments, the dashboard application 125 is stored by the memory 126 of the user device 121 and selectively executable by the processor 129. The program logic may configure the processor 129 of the user device 121 to perform at least some of the functions discussed herein. In some embodiments the dashboard application 125 is a stand-alone application that may be downloaded and installed on the user device 121. In other embodiments, the dashboard application 125 may be a part of another application, such as another governing institution client application. For example and in the embodiment depicted where the governing institution is a financial institution, the dashboard application 125 may be a part of a mobile banking application provided and supported by the governing institution computing system 110.

The depicted downloaded and installed configuration of the dashboard application 125 is not meant to be limiting. According to various embodiments and as alluded to above, parts (e.g., modules, etc.) of the dashboard application 125 may be locally installed on the user device 121 and/or may be remotely accessible (e.g., via a browser-based interface) from the governing institution computing system 110 (or other cloud system in association with the governing institution computing system 110). In this regard and in another embodiment, the dashboard application 125 is a web-based application that may be accessed using a browser (e.g., an Internet browser provided on the user device 121). In still another embodiment, the dashboard application 125 is hard-coded into memory such as memory 126 of the user device 121 (i.e., not downloaded for installation). In an alternate embodiment, the dashboard application 125 may be embodied as a “circuit” of the user device 121 as circuit is defined herein.

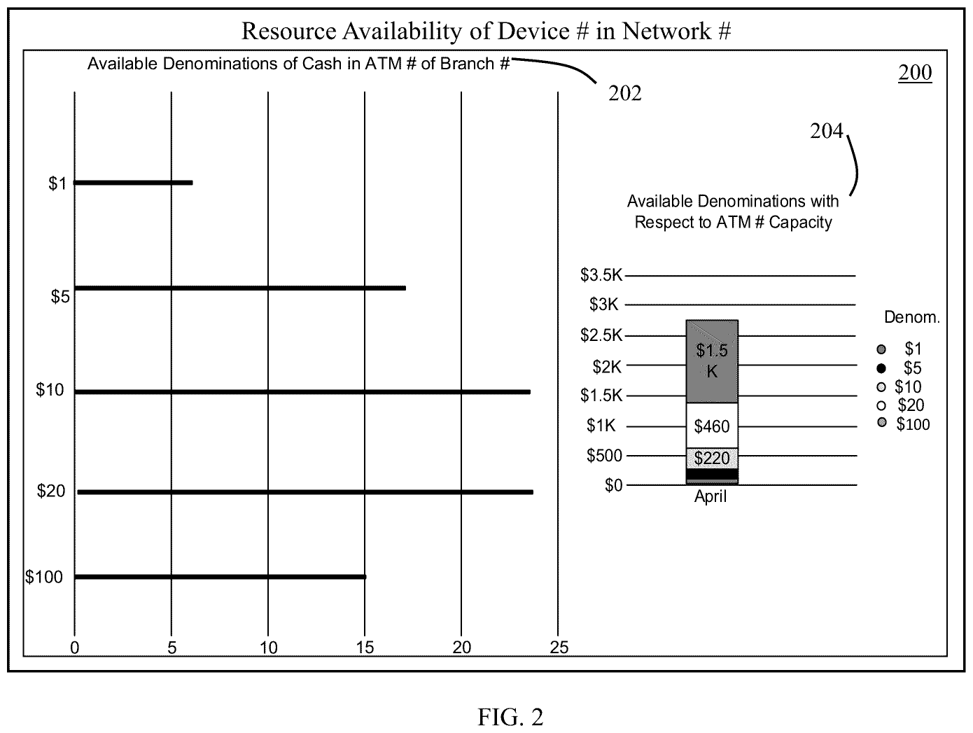

The dashboard application 125 is structured to perform a variety of functions and/or processes to transform operation of the user device 121. The dashboard application 125 may generate and provide one or more graphical user interfaces (GUIs) such the user may view real time or near real time resource availability updates, resource availability notifications, and/or actions recommended by the dashboard circuit 115 of the governing institution computing system 110 to be performed regarding one or more non-integrated storage devices 141 and/or integrated storage devices 131. The dashboard application 125 is configured to receive instructions from the dashboard circuit 115 of the governing institution computing system 110 indicating how to generate/modify/display real time or near real time resource information and user information on GUIs. An example implementation of the dashboard application 125 is described herein, with reference to FIGS. 2-4. Thus, the dashboard application 125 may generate and provide one or more notification, messages, instructions, and the like to the user for transferring resources between devices and/or networks.

The dashboard application 125 may be configured to receive inputs from the user and transmit those inputs to the dashboard circuit 115. The inputs received from the user may include text inputs, audio inputs, mouse clicks, motion-based inputs (e.g., swipes of a touch screen), and/or the like.

In some configurations, the dashboard application 125 may activate a microphone of the user device 121 (e.g., using the input/output circuit 128) such that the microphone captures audio from the user. For example, a mobile device placed in close proximity to the user and configured with a microphone may listen to a user as the user is counting particular denominations. This may enable the dashboard application 125 to track resources (e.g., amount of physical currency, denominations of a physical currency, etc.) at a resource repository device. In some configurations, the dashboard application 125 may request permission from the user before activating the microphone and/or request that the user accept usage of the microphone.

In other configurations, the dashboard application 125 may activate a camera of the user device 121 (e.g., using the input/output circuit 128) such that the camera captures visual data from and regarding the user, non-integrated storage device 141, and/or integrated storage device 131. Visual data captured by the dashboard application may include a number of fingers representing counted denominations, lip movements representing counted denominations, the user placing resources within the non-integrated storage device 141, integrated storage device 131, and/or other resource repository storage device, and the like. For example, a laptop device placed in close proximity to the user and configured with a camera may capture images/video of the user as the user is talking to a customer of a branch, storing resources in resource repository storage devices, and/or counting particular denominations. As described herein, the user device 121 (e.g., the input/output circuit 128) may analyze the captured images/videos using object detection algorithm(s), object recognition algorithm(s), classification algorithm(s), and the like, to identify a quantity of resources stored, lip movements, and/or hand gestures. The dashboard application 125 may either include a table or other information regarding commonly used visual cues (lip movements of numbers, etc.) so that motions of the user are correctly analyzed and determined. In some configurations, the dashboard application 125 may request permission from the user before activating the camera and/or request that the user accept usage of the camera. Additionally, the dashboard application 125 may generate and provide a reply prompt to the captured user motion to confirm the analysis (e.g., “It appears you told the customer there were ten $20 bills, can you confirm?” or “It appears that you just withdrew $100 of cash using four $20 bills and two $10 bills, can you confirm?”). The dashboard application 125 may adjust and/or confirm the captured/analyzed user motion in response to received user input. The dashboard application 125 may receive confirmation of the captured/analyzed user motion, and adjust the information captured regarding the resources transmitted to the dashboard circuit 115 in response to receiving an user input of resources different from the resources analyzed from the captured user motion. Continuing with the example of withdrawn cash identified from user motion above, the user device 121 may receive user input of four $20 bills and four $5 bills. That is, although the dashboard application 125 identified four $20 bills and two $10 bills, the user in fact withdrew four $20 bills and four $5 bills. The user device 121 may transmit the updated resource information to the dashboard circuit 115 of the governing institution computing system 110. Additionally or alternatively, the user device 121 may receive user input only of the difference in captured/analyzed data to actual data. That is, the user device 121 may receive user input only of four $5 bills, indicating that the determined four $20 bills was accurate. This type of tracking may be beneficial as a way to keep track of resource quantities and denominations in devices that may not include automatic counting/sensing devices.

The inputs transmitted from the dashboard application 125 of the user device 121 to the dashboard circuit 115 of the governing institution computing system may be an indication of available resources in resource repositories such as non-integrated storage devices 141 and/or integrated storage devices 131 (e.g., an automatically counted denomination determined by a TCR and entered into the dashboard application 125 by a user, a manually counted denomination determined by a user and entered into the dashboard application 125 by a user). As described herein, non-integrated storage devices 141 are devices in which the storage device simply stores resources. The non-integrated storage devices 141 may be cassettes, teller drawers, drop bags, and the like. In contrast, integrated storage devices 131 may communicate resource information to the governing institution computing system 110 across network 101 and/or to the user device 121. The integrated storage devices 131 are characterized by having automated counting capabilities and/or network connectivity capabilities such as ATMs, TCRs, and the like. Inputs transmitted from the dashboard application 125 to the dashboard circuit 115 may also include an indication of a completed action, and/or a request from the user device 121 to re-transmit a notification/message alerting a user to perform an action to one or more other user devices.

The input/output circuit 128 includes communication circuitry for facilitating the exchange of data, values, messages, and the like between an input/output device and the user of the user device 121. In yet another embodiment, the input/output circuit 128 includes machine-readable media for facilitating the exchange of information between an input/output device and the user. In still another embodiment, the input/output circuit 128 includes any combination of hardware components, communication circuitry, and machine-readable media. Hardware components can include a touchscreen, a keypad, microphone, camera, or buttons for receiving user inputs. Components of the input/output circuit 128 display text, and/or transmit audio to/from the user. For example, the input/output circuit 128 may be configured to capture audio from the user (using a microphone, for instance) and/or capture tones such as dual-tone multi-frequency (DTMF) signals selected by the user (using a keypad, for instance). Additionally or alternatively, the input/output circuit 128 may be configured to display graphics including dynamic GUIs generated by the dashboard application 125 and/or dashboard circuit 115. In one embodiment, the display is a touchscreen display that is capable of detecting user touches, e.g., to provide user inputs. In other embodiments, the user may generate user inputs via a mouse, keyboard, and the like.

As alluded to above, the input/output circuit 128 can include and/or be communicably coupled to a camera, a proximity sensor, or another type of nearby-monitoring device to monitor real-time, or near real-time activity regarding the user device 121. In some arrangements, a sensor and the camera can be used in a combined arrangement such that operation of the camera is triggered by the sensor. As such, upon the detection of movement occurring outside the user device 121, the sensor can communicate a detection signal to the camera, which begins recording the activity near the user device 121 in response to the communicated detection. In an example, the camera captures/records activity occurring proximate the user device 121 such as the user counting/distributing/receiving resources adjacent to the user device 121. The captured data can be analyzed by various circuits included in the user device 121 (e.g., the input/output circuit 128). For instance, the input/output circuit 128 may identify resources by applying the captured images/videos from the camera to one or more image processing/classification algorithms. In a non-limiting example, the input/output circuit 128 identifies denominations of cash (e.g., $1 bills, $5 bills, etc.) handled by the user and deposited into a repository device proximate to the user device 121, with such information being captured via one or more images/videos. In an alternate example, the camera captures/records one or more machine-readable features (e.g., barcode, QR code, etc.) coupled to a resource. In a non-limiting example, the camera coupled to or included with the input/output circuit 128 of the user device 121 scans a barcode on a wrapper storing (or holding or containing) resources identifying a particular denomination of resources contained in the wrapper. In another non-limiting example, the camera of the input/output circuit 128 of the user device 121 scans a QR code on a cash drawer or other resource repository identifying a particular denomination of cash contained in the cash drawer. The QR code, barcode, and/or other machine-readable feature may contain resource information, such as quantity, denomination breakdown, date of assembly, etc. The machine-readable feature may be read/scanned by the user device 121 and such information transmitted to the governing institution computing system 110.

Thus, in operation, the user device 121 (via the dashboard application 125, which may be in the form of a pop-message or other messaging type) may receive an instruction from the governing institution computing system 110 regarding a resource and/or resource repository device (e.g., move certain resources from a first resource device to a second resource device, switch cassettes between two ATMs, investigate/review a particular device, etc.). When the action (i.e., transfer) occurs, the user device 121 may acquire information regarding the resource repository device and/or resource stored therein subsequent to the instruction by, as mentioned above, images from a camera device of the user device 121 and so on. The images and/or other information may be analyzed by the user device 121 and transmitted back to the governing institution computing system 110. The analyzed images may contain information regarding a counted number of bills, a sum of the counted funds, a weight of the funds, a currency type (e.g., Euros versus USD), and so on. The governing institution computing system 110 may receive this information (e.g., notification) and compare it with information associated with the instruction (e.g., a sum and a denomination make-up for the transfer, etc.). If a match, the governing computing system 110 may take no action and mark transfer as complete in the system. If there is a discrepancy, the governing institution computing system may take a variety of actions, such as following up with the user via the user device 121 for additional information, analyzing information from integrated storage devices that were a part of the resource movement (e.g., whether the newly deposited resource amount matches the determined/instructed amount), send a message to a manager device of a manager that supervises the user, etc.

The user device 121 may also include an API gateway 123. The API gateway 123 may be configured to facilitate the transmission, receipt, authentication, data retrieval, and/or exchange of data between the components (e.g., applications, etc.) of the user device 121 and/or governing institution computing system 110.

An API is a software-to-software interface that allows a first computing system of a first entity to utilize a defined set of resources of a second (external) computing system of a second (third-party) entity to, for example, access certain data and/or perform various functions. In such an arrangement, the information and functionality available to the first computing system is defined, limited, or otherwise restricted by the second computing system. To utilize an API of the second computing system, the first computing system may execute one or more APIs or API protocols to make an API “call” to (e.g., generate an API request that is transmitted to) the second computing system. The API call may be accompanied by a security or access token or other data to authenticate the first computing system and/or a particular user. The API call may also be accompanied by certain data/inputs to facilitate the utilization or implementation of the resources of the second computing system, such as data identifying users (e.g., name, identification number, biometric data), financial information, dates, functionalities, tasks, etc. The API gateway 123 in the user device 121 provides various functionality through APIs by accepting API calls via the API gateway 123. The API calls may be generated via an API engine of a system or device (e.g., user device 121 and/or governing institution computing system 110) to, for example, make a request from another system or device.

The non-integrated storage devices 141 and integrated storage devices 131, also referred to herein as resource repository devices or resource repository storage devices, are devices that are configured to retrievably store resources. In some embodiments, each integrated storage devices 131 and non-integrated storage device 141 is associated with a unique identifier (e.g., a device serial number, a number assigned to the device, other identifier, etc.). The unique identifier may be determined by the governing institution computing system 110 (e.g., an incremented counter that counts/tracks each device and assigns a new value to each new device). The unique identifier may also be linked to the user identifier(s)/user account(s) associated with users, who are currently assigned to the integrated storage devices 131/non-integrated storage device 141. The governing institution computing system 110 may use the unique identifier associated with the integrated storage devices 131/non-integrated storage device 141 to track activity regarding the integrated storage devices 131/non-integrated storage device 141 for record keeping purposes and/or security purposes.

In one embodiment and as described herein, the “resources” are physical currency, such as Euros, U.S. cash, coins, etc. Non-integrated storage devices 141 are devices in which the storage device simply stores resources. The non-integrated storage devices 141 may be cassettes, teller drawers, drop bags, and the like. A user responsible for operating a non-integrated storage device 141 may input resource information (e.g., quantities of cash denominations deposited and/or withdrawn) into the dashboard application 125 using the input/output circuit 128 of the user device 121 such that the governing institution computing system 110 receives the resource information. In contrast, integrated storage devices 131 may communicate resource information to the governing institution computing system 110 across network 101 and/or to the user device 121. The integrated storage devices 131 are characterized by having automated counting capabilities and/or network connectivity capabilities such as ATMs, TCRs, and the like.

The network interface circuit 134 is structured to receive communications from and provide communications to the governing institution computing system 110 and/or user device 121. In this regard, the network interface circuit 134 is structured to exchange data, communications, instructions, and the like with the governing institution computing system 110 and/or user device 121. For example, the network interface circuit 134 may transmit resource information (e.g., resource quantities such as a particular numbers of counted denominations), a device identifier of the device storing the resource (e.g., a serial number, a labeled number by an administrator), a timestamp associated with when the resource information was obtained/retrieved, information regarding a user who accessed the resource (e.g., user device identifier, etc.), and the like to the governing institution computing system 110 and/or user device 121.

The network interface circuit 134 is structured or adapted for and configured to establish a communication session via the network 101 with the governing institution computing system 110 and/or user device 121. The network interface circuit 134 includes programming and/or hardware-based components that couple the integrated storage device 131 to the network 101. For example, the network interface circuit 134 may include any combination of a wireless network transceiver (e.g., a cellular modem, a Bluetooth transceiver, a Wi-Fi transceiver) and/or a wired network transceiver (e.g., an Ethernet transceiver). In some arrangements, the network interface circuit 134 includes the hardware and machine-readable media structured to support communication over multiple channels of data communication (e.g., wireless, Bluetooth, near-field communication, etc.). Further, in some arrangements, the network interface circuit 134 includes cryptography module(s) to establish a secure communication link (e.g., using the IPSec protocol or similar) in which data communicated over the link is encrypted and securely transmitted. In this regard, financial data (or other types of data) may be encrypted and transmitted to prevent or substantially prevent the threat of hacking or unwanted sharing of information. To support the features of the integrated storage device 131, the network interface circuit 134 provides a relatively high-speed link to the network 101, which may be any combination of a local area network (LAN), an intranet (e.g., a private banking or retailer network), the Internet, or any other suitable communications network, directly or through another interface.

The processing circuit 132 may include at least one memory 136 coupled to a processor 139. The memory 136 includes one or more memory devices (e.g., RAM, NVRAM, ROM, Flash Memory, hard disk storage) that store data and/or computer code for facilitating at least some of the various processes described herein. That is, in operation and use, the memory 136 stores at least portions of instructions and data for execution by the processor 139 to control the processing circuit 132. The memory 136 may be or include tangible, non-transient computer-readable volatile memory and/or non-volatile memory. The processor 139 may be implemented as one or more processors, application specific integrated circuits (ASICs), field programmable gate arrays (FPGAs), digital signal processors (DSPs), and/or other suitable electronic processing components.

The input/output circuit 138 includes communication circuitry for facilitating the exchange of data, values, messages, and the like between an input/output device and the user of the integrated storage device 131. In yet another embodiment, the input/output circuit 138 includes machine-readable media storing instructions configured to, when executed, facilitate the exchange of information between an input/output device and the user of the integrated storage device 131. In still another embodiment, the input/output circuit 138 includes any combination of hardware components, communication circuitry, and machine-readable media. Hardware components can include a touchscreen, a keypad, microphone, camera, or buttons for receiving user inputs. Components of the input/output circuit 138 display text, and/or transmit audio to/from the user. For example, the input/output circuit 138 may be configured to read out (using a microphone, for instance) a number of identified resources (e.g., a number of counted denominations, such as ten twenty-dollar bills). Additionally or alternatively, the input/output circuit 138 may be configured to display graphics such as icons and text to display a number of identified resources. In one embodiment, the display is a touchscreen display that is capable of detecting user touches, e.g., to provide user inputs. In other embodiments, the user may generate user inputs via a mouse, keyboard, and the like.

As alluded to above, the input/output circuit 138 can include and/or be communicably coupled to a camera or another sensing/monitoring device (e.g., weight sensor, proximity sensor, etc.) to monitor real-time or near real-time activity surrounding the integrated storage device 131 and/or occurring within the integrated storage device 131. In a first example, the camera captures/records activity performed within the integrated storage device 131 such as automatically counting resources received, taken from, and/or stored in the integrated storage device 131. In a second example, the camera captures/records activity occurring proximate the integrated storage device 131 such as the integrated storage device 131 receiving resources and/or distributing resources to a user. The captured data can be analyzed by various circuits included in the integrated storage device 131 (e.g., the input/output circuit 138). For instance, the input/output circuit 138 may identify resources by applying the captured images/videos from the camera to one or more image processing/classification algorithms. In a non-limiting example and based on one or more images from the camera, the input/output circuit 138 identifies denominations of cash (e.g., $1 bills, $5 bills, etc.,) deposited into the integrated storage device 131 or withdrawn from the integrated storage device 131 via the captured images/videos. In an alternate example, the camera captures/records one or more machine-readable features (e.g., barcode, QR code, etc.) coupled to a resource to track movement into/out of the storage device 131.

As alluded to above, the input/output circuit 138 can also include and/or be communicably coupled to various sensors which are configured to detect movement and proximity of objects near or inside the integrated storage device 131. In a non-limiting example, a motion detector sensor is included with or coupled to the input/output circuit 138 to detect movement of objects near and/or within the integrated storage device 131. In various arrangements, motion detector sensors include, but are not limited to, passive infrared sensors, microwave motion detectors, ultrasonic detectors, proximity sensors, heat detectors, weight sensors, etc., which are used to detect movement proximate the integrated storage device 131 or occurring within the integrated storage device 131. The movements can include, but are not limited to, weight changes in the integrated storage device 131, infrared changes in the integrated storage device 131, voltage changes across an electrical conductor in the integrated storage device 131, etc. The sensors may also scan/read or otherwise acquire information from one or more machine-readable feature disposed within the device 131 (e.g., a QR code printed on a wrapping holding a stack of resources). In some arrangements, the sensor and camera can be used in a combined arrangement such that operation of the camera is triggered by the sensor. In a first example, in response to detecting movement occurring outside the integrated storage device 131 the sensor (e.g., the motion detector sensor, heat sensor, proximity sensor, etc.) can communicate a detection signal to the camera, which begins recording the activity near or within the integrated storage device 131 in response to the communicated detection. Additionally or alternatively, in response to detecting movement occurring within the integrated storage device 131 (e.g., one or more mechanisms in the integrated storage device 131 begin moving resources stored in the integrated storage device 131), the sensor can communicate a detection signal to the camera. In a second example, in response to detecting that a weight has changed within the integrated storage device 131, the sensor (e.g., a weight sensor) can communicate a detection signal to the camera, which begins recording/capturing the resources within the integrated storage device 131 to determine (or identify) the resources being removed.

Integrated storage devices 131 may be configured to execute a variety of functions, such as tracking/monitoring, classifying, and/or identifying received/disbursed resources. For example and as described above, image processing functions may identify a denomination of received cash from video data and/or photographic data captured from a sensor such as a camera from the input/output circuit 138. For example, image objects, or clusters of related pixels in a captured image of a received resource may be compared to characters in a character and/or font database to identify whether a received denomination was a $5 bill or a $20 bill. Additionally or alternatively, the integrated storage devices 131 may be configured to transmit the images to the governing institution computing system 110 to identify the received bank notes (using image processing, for instance).

Still referring to FIG. 1, the computing system 100 also includes a governing institution computing system 110. The governing institution computing system 110 is associated with a governing or provider institution, such as financial institution operating multiple bank branches, a retail brand with multiple retail locations, and so on. In the example shown, the governing institution is a financial institution that manages a plurality of retail or branch locations. As described herein, the governing institution (e.g., the financial institution) manages resources across various networks (e.g., bank branches, separate locations of a branch such as a separate location containing pneumatic tubes relative to another location containing an ATM, etc.). Each of the networks of the governing institution includes devices that may retrievably store resources (e.g., vaults, teller drawers, teller cash recyclers, automated teller machines, cassettes, point of sale devices, pre-staged lockers, drop bags of cash etc.). These devices may be integrated or non-integrated devices. The devices may be configured to store a particular resource (e.g., a particular denomination or type of bill) and/or mixed combination of resources. Customers of the governing institution (e.g., clients, patrons, members) may interact with users of the governing institution and/or devices of the governing institution to exchange resources. For instance, customers may deposit cash and/or withdraw cash, thereby altering the available cash stored in the devices of the governing institution.

The governing institution computing system 110 may be structured as one or more server computing systems, for example, comprising one or more networked computer servers having a processor and non-transitory machine readable media. In the example shown, the governing institution computing system 110 includes a network interface circuit 114, a processing circuit 112 having a memory 116 and a processor 119, a dashboard circuit 115, an input/output circuit 118, an API gateway 113, and an authentication circuit 106. The network interface circuit 114 is structured to receive communications from the user device 121 and/or integrated storage device 131, and provide communications, in real time or near real time, regarding resource information to the user via the user device 121. The network interface circuit 114 is structured to exchange data, communications, instructions, and the like with the user device 121. For example, the network interface circuit 114 may receive resource information as described herein from the integrated storage devices 131, user device 121, and/or other device or system. The network interface circuit 114 may transmit notifications/alerts, including one or more actions to be performed by one or more users, to user devices 121.

The network interface circuit 114 includes programming and/or hardware-based components that connect the governing institution computing system 110 to the network 101. For example, the network interface circuit 114 may include any combination of a wireless network transceiver (e.g., a cellular modem, a Bluetooth transceiver, a Wi-Fi transceiver) and/or a wired network transceiver (e.g., an Ethernet transceiver). In some arrangements, the network interface circuit 114 includes the hardware and machine-readable media structured to support communication over multiple channels of data communication (e.g., wireless, Bluetooth, near-field communication, etc.) Further, in some arrangements, the network interface circuit 114 includes cryptography module(s) to establish a secure communication link (e.g., using the IPSec protocol or similar) in which data communicated over the link is encrypted and securely transmitted. In this regard, financial data (or other types of data) may be encrypted and transmitted to prevent or substantially prevent the threat of hacking or unwanted sharing of information. To support the features of the governing institution computing system 110, the network interface circuit 114 provides a relatively high-speed link to the network 101, which may be any combination of a local area network (LAN), an intranet (e.g., a private banking or retailer network), the Internet, or any other suitable communications network, directly or through another interface.

The processing circuit 112 may include at least one memory 116 coupled to a processor 119. The memory 116 includes one or more memory devices (e.g., RAM, NVRAM, ROM, Flash Memory, hard disk storage) that store data and/or computer code for facilitating at least some of the various processes described herein. That is, in operation and use, the memory 116 stores at least portions of instructions and data for execution by the processor 119 to control the processing circuit 112. The memory 116 may be or include tangible, non-transient volatile memory and/or non-volatile memory. The processor 119 may be implemented as one or more processors, application specific integrated circuits (ASICs), field programmable gate arrays (FPGAs), digital signal processors (DSPs), and/or other suitable electronic processing components.

The memory 116 may hold, store, categorize, and/or otherwise serve as a repository for resource information of various user devices 121, non-integrated storage devices 141 and/or integrated storage devices 131 in one or more networks (e.g., branches) of the governing institution computing system 110. The memory 116 may be structured to store information, such as resource capacity for resource repository devices (e.g., non-integrated storage devices 141 and/or integrated storage devices 131), resource capacity in each network of a system, denomination capacity in the resource repository devices, hours of operation for resource repository devices, hours of operation of a user device 121, hours of operation of different networks in a system (e.g., branch 1 may be open daily while branch 2 may be open on weekdays only), user information and corresponding user profiles including user experience/seniority, user schedules, devices associated with the user, user names, user contact information (e.g., email address, physical address, phone number of the account holder, user privileges (e.g., user accounts/identifiers authorized to access certain devices, user accounts/identifiers authorized to move/transport resources, restrictions/limitations associated with any user account/identifier, etc.), security codes required to access devices, and so on. Thus, the memory 116 may track and store activity regarding users and historic device/network usage patterns.

The authentication circuit 106 may be configured to authenticate the user (or the user device 121) via authenticating information received from the user device 121. In some configurations, the governing institution computing system 110 may not transmit resource information (e.g., via a GUI of the dashboard application 125) unless the user (and/or the user device 121) has been authenticated via the authentication circuit 106. For example, the authentication circuit 106 may receive a credential (username and password, answer to security question, passcode, biometric information, etc.) to initiate the dashboard GUI such that the dashboard circuit 115 only deploys resources for an authenticated user/user device 121 thereby improving overall operation and security of the computing system by deploying resources in an on-demand manner. This authentication may be in addition to or in place of authentication that may be required to access/use the dashboard application 125.

The authentication circuit may also authenticate a user/user device 121 based on certain actions, such as if the user taps the user device 121 to a short-range communication device (e.g., PIN pad at a branch location, etc.) (e.g., by transmitting a token, such as a device token, that is correlated to a specific account of the governing institution computing system 110 to confirm that the user device 121 is associated with a user account). In another embodiment, the user device 121 receives (instead of transmits) a token from the short-range communication device at the branch that enables the user device 121, via the dashboard application 125, to pass the received token to the governing institution computing system 110 to then authorize the user and corresponding user device 121. For example, the integrated storage device may store an identifier that is transmitted to the user device 121 via a short-range wireless communication that is then used to allow the user to access the integrated storage device based on the user identifier corresponding to an access privilege for the device. In this way, access to the integrated storage device is governed, at least in part, by information stored in the device.

The authentication circuit 106 may also be configured to identify and authorize users with specific privileges. The user's privileges are associated/linked to the user via a user account or profile. One or more data fields in the user account may indicate the privileges of the user associated with the user account. For example, some users are authorized/have permission to move resources above certain thresholds, some users are authorized/have permission to access certain devises, some users are authorized/have permission to transfer resources, and the like.

The authentication circuit 106 authenticates users such that the authenticated users receive access to data, are authorized to perform actions, receive access to storage devices, or some combination, and the like. In a non-limiting example, the authentication circuit 106 authenticates a user as being associated with the governing institution such that users not affiliated with the governing institution do not have access to sensitive information (such as financial information). In some embodiments and as alluded to above, the authentication circuit 106 may prompt the user to enter or provide user credentials (e.g., username, password, security questions, and biometric information such as fingerprints or facial recognition) via the dashboard application 125. That is, the user may log into dashboard application 125. The authentication circuit 106 may look-up and match the information entered by the user to stored/retrieved user account information in memory 116 to determine whether the user is authorized, and to determine any privileges, permissions, and/or restrictions associated with the user account. For example, memory 116 may contain a lookup table matching user authentication information (e.g., name, home address, IP address, MAC address, phone number, biometric data, passwords, usernames) to authenticated users (e.g., employees of the governing institution) and/or permissions of each of the authenticated users (e.g., data access, device access, etc.) via the user's account. The dashboard circuit 115 is structured to at least partly support the dashboard application 125. In one embodiment, the dashboard circuit 115 is a circuit (e.g., processing circuit) of the governing institution computing system 110. In another embodiment, the dashboard circuit 115 is embodied as program logic (e.g., modules, etc.) that may be stored by the memory 116 and executed by the processor 119. The program logic may configure the processor 119 of the governing institution computing system 110 to perform at least some of the functions discussed herein. In the example shown, the dashboard circuit 115 is a dedicated hardware circuit including program logic that supports and enables at certain processes described herein. However, this depiction is not meant to be limiting.

The dashboard circuit 115 is structured to receive monitored resource data from the user device 121 and/or integrated storage device 131 and perform a variety of functions to communicate in real time or near real time with a user (e.g., a user over the network 101 using a user device 121) in order to provide resource information, notifications, and/or actions to the user. The dashboard circuit 115 is shown to include a rules circuit 103 and a machine learning circuit 111. In this embodiment, the rules circuit 103 and the machine learning circuit 111 of the dashboard circuit 115 are embodied as program logic.

The dashboard circuit 115 is configured to receive and analyze resource information from the user devices 121, non-integrated storage devices 141 and/or integrated storage devices 131 of a system. In some implementations, the dashboard circuit 115 may aggregate resource information from devices to determine network resource information. The dashboard circuit 115 is configured to analyze the received resource information to determine whether the resource distribution of device(s) and/or network(s) can be optimized. Resource distribution may be optimized by balancing the device(s) and/or networks to recycle resources, recirculating resources in device(s) and/or network(s), and/or removing resources from device(s) and/or network(s) to support future resource utilizations.

The rules circuit 103 may store a plurality of rules, and compare one or more rules to monitored resource information in response to receiving monitored information from user devices 121, non-integrated storage devices 141 and/or integrated storage devices 131. In some implementations, the rules circuit 103 compares predetermined rules to monitored resource information and predicted resource information, determined by the machine learning circuit 111 described herein.

The predetermined rules from the rules circuit 103 are configured to identify devices and/or networks that are approaching a predefined suboptimal operating status (e.g., devices are empty of one or more particular resources, devices are full of one or more particular resources, a combination thereof, etc.). The rules circuit 103 may store preconfigured rules for each device individually, a group of devices, each network individually (because a branch in one location may have rules different from a branch in a different location), and/or a group of networks (e.g., all branches, all branches in a city). For instance, each ATM device in a network may be configured with different thresholds (e.g., a different desired ceiling amount of resources stored in the ATM device as compared to other ATM devices). In a non-limiting example, a rule for a particular ATM may restrict that ATM from storing fewer than ten $20 bills. If that ATM identifies that there are fewer than ten $20 bills stored, the ATM may satisfy the predetermined rule, which as described herein, may function as a trigger condition for implementing one or more actions. In another non-limiting example, a rule for a network (branch) may restrict the branch from holding over $70,000.00 (i.e., an amount/sum across the devices in the branch, such as all the ATMs in the branch, the vault of the branch, the teller devices of the branch, and the like).

Different devices and/or networks may be associated with different rules. In a non-limiting example, a first device may be associated with a threshold that is smaller than a threshold associated with a second device. That is, a teller with less experience may be assigned to a teller device with a reduced capacity of resources as compared to a capacity of resources in a teller device assigned to a teller with more experience. Further, different resources may be associated with different rules in the same device and/or network.

Moreover, the rules circuit 103 may be configured with different rules for different circumstances (e.g., constraints). For instance, the rules configured for one day of a week (e.g., Friday) may be different from the rules configured on a different day of the week (e.g., Tuesday). In response to a rule being satisfied, an action is selected and implemented.

The rules circuit 103 may employ lookup tables with thresholds and recommended actions to rebalance resources. The thresholds and corresponding actions may be determined by users of the governing institution computing system 110 and/or the rules circuit 103 via historic resource information. In a first example, users may determine thresholds based on user experience, device usage history, and/or some combination. In a second example, the rules circuit 103 may determine thresholds based on device usage history and/or historic resource information. For example, in response to evaluating resource information (e.g., resource availability in a particular device) at different points in time, the rules circuit 103 may map thresholds and corresponding actions. In a non-limiting example, the resources in the repository device at a first time period may include thirty $1 bills, the resources in the repository device at a second time period may include fifteen $1 bills, and the resources in the repository device at a third time period may include twenty $1 bills. The rules circuit may learn, iteratively and over time, by comparing the state of the resources at various points in time, a threshold number of resources (e.g., $1 bills) at various times and then determine thresholds for those times. The rules circuit 103 determines the action (e.g., restocking the number of $1 bills) based on a predictable increase in the number of $1 bills to twenty $1 bills, when a threshold number of $1 bills is identified in the repository device. That is, the rules circuit 103 maps the rule (e.g., a particular resource being less than a threshold) to an action (e.g., restocking the particular resource). The rules circuit may learn thresholds for each type of resource. For example, the rules circuit 103 may learn a threshold and corresponding action for $1 bills, and a different threshold and/or corresponding action for $100 bills, based on resource information.

In another illustrative example, a device may recycle resources (e.g., receive resources and dispense the received resources). Accordingly, the rules associated with that device may be specific to that device and the resource usage patterns of that device. For instance, different rules may be predetermined for different resources of that device. That is, the thresholds, as determined by the rule circuit 103 and/or user, are determined to prevent the device from entering into a full state or an empty state (suboptimal operating state). If the device is in a full state, the device is incapable of receiving resources. If certain resources of the device are in an empty state, the device is incapable of dispensing those certain resources when desired. Accordingly, the device is in a state that facilitates resource recycling if each of the resources of the device are maintained within a range. While balancing the resource to prevent the device from entering a full state or an empty state beneficially allows resource flow (e.g., resource deposits into the device and resource withdraws from the device), there may be other advantages to maintaining the device in a full state or an empty state.

In some embodiments, there may be one or more intermediate thresholds that may be used to flag devices and/or networks. The dashboard circuit 115 may determine to set a flag regarding at least one of a network or resource repository device. A flagged device and/or network is a device and/or network that has not yet satisfied a trigger condition, but has satisfied one or more intermediary conditions (rules, thresholds). Flagged devices, including resource information such as the quantity of resources and the time that the device is flagged, may be stored in memory 116 using the unique device identifier.

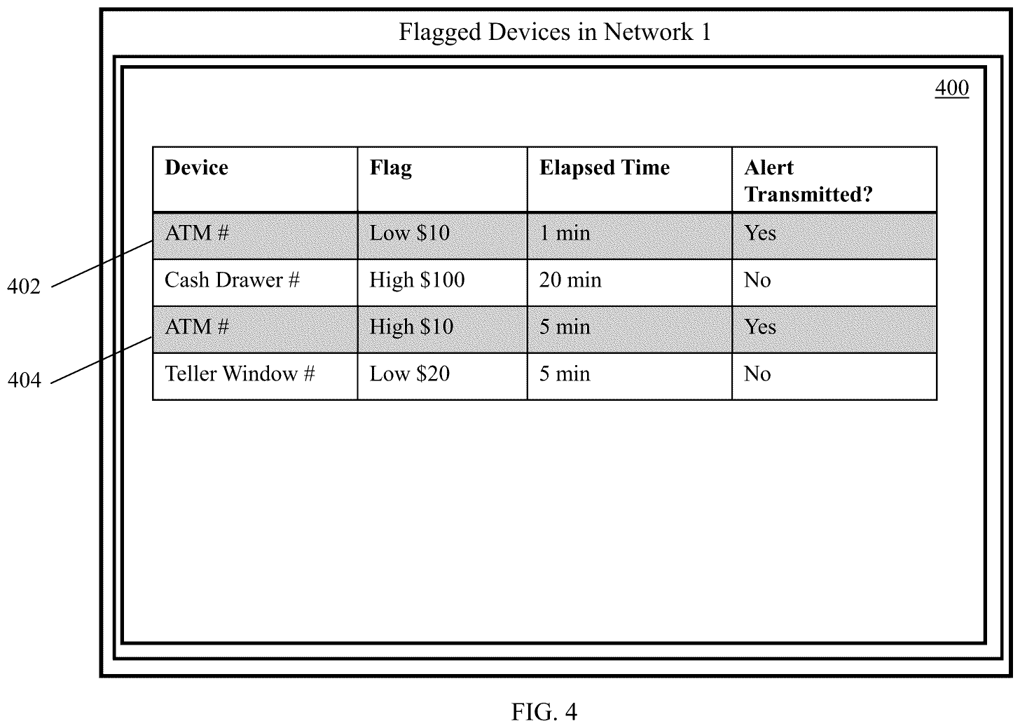

The dashboard circuit 115 may determine to set a flag regarding at least one of a network or resource repository device based on one or more rules, referred to as intermediary rules (or intermediary thresholds), of the rule circuit 103. Setting a flag may include generating an indicator regarding the intermediary rule of the rule circuit 103. For example, an intermediary rule of the rule circuit 103 may define a low quantity threshold that indicates a low quantity of resources (e.g., certain denominations). In these embodiments, the indicator of the flagged device may be a data field appended to the unique device identifier data indicating a number mapped to the corresponding intermediary rule. If the available number of resource in the device satisfy the low quantity resource threshold, then the device may be flagged by the dashboard circuit 115 as having a low quantity of a particular resource. If the flagged device/network is not addressed, the continuing exchange of resources at the flagged device/network may likely result in the flagged device/network satisfying a triggering condition (e.g., a resource threshold). In some implementations, the dashboard circuit 115 may keep track of the duration of time a network/device has been flagged. For example, the dashboard circuit 115 may initialize a counter/timer when the network/device is flagged by the rule circuit. As described herein, the flagged device may be used by the dashboard circuit 115 when determining whether the device is capable of participating in resource recirculation. That is, a device that has been flagged to be low of a particular denomination may receive the particular denomination from a device that has been flagged to be high of the particular denomination. The recirculation feature is further described with reference to FIG. 4.

Referring now to FIG. 4, a GUI 400 illustrating flagged devices on a user device is shown, according to an example embodiment. The GUI 400 may include a table (or chart, graph, list, etc.) that provides an indication of the devices that have been flagged. For instance, the unique identifiers associated with each integrated storage device 131 and non-integrated storage device 141 may be displayed, and/or the user associated with the device may be displayed (e.g., user account, user name). The GUI 400 may also indicate a cause that triggered the flag. That is, the GUI 400 may indicate which intermediary threshold(s) were satisfied by the rule circuit 103. The GUI 400 may also display an elapsed time that the device has been flagged. In some embodiments, if the duration of elapsed time satisfies a threshold, the dashboard circuit 115 uses the rule circuit 103 to map an action to the closest threshold. That is, although a threshold for mapping an action to the received resource data is not satisfied, the duration of the flagged device indicates that the resource flow of the device may need to be modified (e.g., by stocking the device with resources or removing resources from the device). For instance, if a device is flagged for having a low particular resource, after a predetermined duration of time, the rules circuit 103 is triggered to map the low resource to a restocking action. The GUI 400 may also indicate whether a user was alerted to the flagged device.

The dashboard circuit 115 may continuously (or periodically) compare the flagged devices stored in memory 116 to other flagged devices stored in memory 116 to optimize or attempt to optimize resource opportunities in a network using resource recirculation. For example, ATM 402 in FIG. 4 may have been flagged by the rule circuit 103 for having a low available number of $10 bills. Further, ATM 404 may have been flagged by the rule circuit 103 for having a high available number of $10 bills. As shown, ATM 402 in Network 1 may require an increase in the quantity of $10 bills to improve the likelihood that a customer seeking to withdraw $10 bills is able to withdraw $10 bills from ATM 402. Further, ATM 404 in Network 1 may require a decrease in the available number of $10 bills to improve the likelihood that a customer seeking to deposit $10 bills is able to deposit $10 bills. Accordingly, by comparing the flagged devices, the dashboard circuit 115 is configured to determine in real time or near real time that the demand of ATM 402 is able to satisfy the supply of ATM 404. To improve the recirculation in Network 1 (reducing the cost of transporting resources), the dashboard circuit 115 may transmit an alert to a user (e.g., the user in charge of managing ATM 402 and/or the user in charge of managing ATM 404) to transfer the extra available $10 bills of ATM 404 to ATM 402.

Referring back to FIG. 1, the dashboard circuit 115 may transmit a notification/message to a user device 121 based on the monitored resources and/or the predicted resources satisfying a trigger condition (e.g., a threshold defined by the rule circuit 103). In some implementations, before the dashboard circuit 115 transmits the notification, the dashboard circuit 115 may be configured to determine whether the user associated with the user device 121 has permission and/or is available to receive the notification. In this regard, the dashboard circuit 115 may couple to a plurality of user devices 121 (via the dashboard application 125) and sync with the computerized schedules regarding the users stored therein. The schedules may provide an indication of appointments, locations (and time durations at the locations) of the user, and other information regarding the user associated with the user device 121. The dashboard circuit 115 may then identify users who i) have availability, and ii) are nearby (e.g., within a predefined distance) of various resource repositories that may have been flagged (e.g., being in a critical state). Of these identified users, the dashboard circuit 115 may then review their user profiles to determine who has the required privilege to access and transfer resources from the flagged resource repository (ies). Based on this identification, the dashboard circuit 115 may generate and transmit a notification to a user device 121 of a user satisfying these criteria in order to effectuate a resource transfer (e.g., a movement of resources from a first resource depository device to a second resource depository device). In sum, the dashboard circuit 115 may identify the user based on stored characteristics of the user, a required timing for a transfer of the first resource to the second resource repository, a location of the user device, and an availability of the user based on the computerized schedule of the user.

In some embodiments, the dashboard circuit 115 may be constrained to transmit alerts to user devices 121 within a predefined time window (e.g., certain hours such as hours of operation). As an example, the dashboard circuit 115 may be constrained to transmit alerts to user devices 121 if the non-integrated storage device 141 (or other device) will be unattended for a predetermined duration of time. For instance, the dashboard circuit 115 may not transmit an alert to restock an ATM the evening before the ATM is closed to the public because storing resources in a device that is inaccessible to the public may be undesired (e.g., for operational efficiency purposes, security purposes, safety purposes).

The dashboard circuit 115 may communicate a notification regarding the determined action to the user device 121 (using a push notification, email, etc.) such that a user is alerted to take action (e.g., move resources between resource repository devices). The notification communicates the action determined by the rule circuit 103 by instructing the dashboard application 125 to perform a hardware action. For instance, the dashboard circuit 115 may instruct the dashboard application 125 to activate a speaker on the user device 121 to audibly communicate to the user of the user device 121 that the dashboard application 125 has identified an action for the user to perform. In other implementations, the dashboard application 125 may be configured to audibly communicate the action to the user (e.g., “please transfer cassette 1 of ATM 1 to ATM 2”) via a speakerphone of the user device 121 (e.g., the input/output circuit 128). Additionally or alternatively, the dashboard circuit 115 may instruct the dashboard application 125 to flash a light (e.g., a camera flash) on the user device 121 to visually communicate to the user that the user is being instructed to perform an action (e.g., the dashboard application 125 has identified an action for the user to perform). User's may configure alert preferences (e.g., alert only when rule thresholds are satisfied, alert when devices are flagged, alert as to network capacity periodically, alert audibly, alert using haptic feedback, alert using lights) using the dashboard application 125 and/or dashboard circuit 115. The action communicated via a notification/message to the user using the user device 121 may include the action (e.g., transferring a cassette), a location of where the action is to be performed, a device number identifying the device where the action is to be performed, a time that the action should be completed by, a time that the action should be performed, and the like.

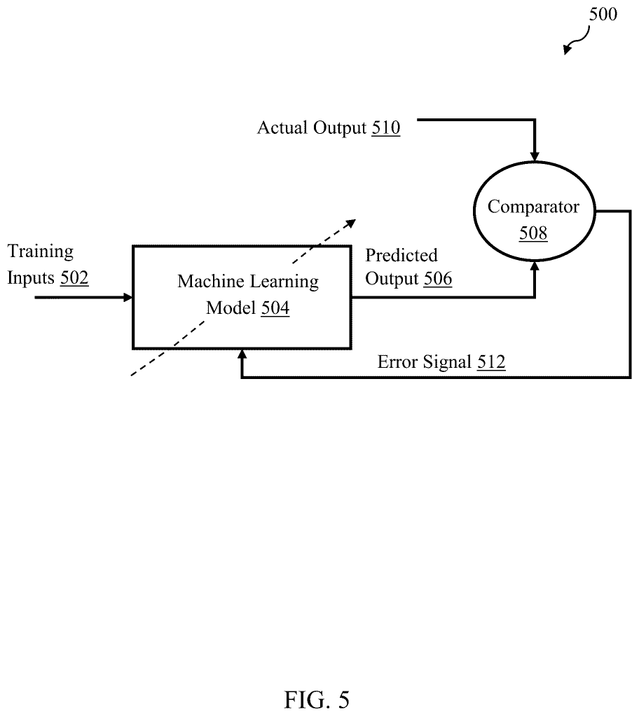

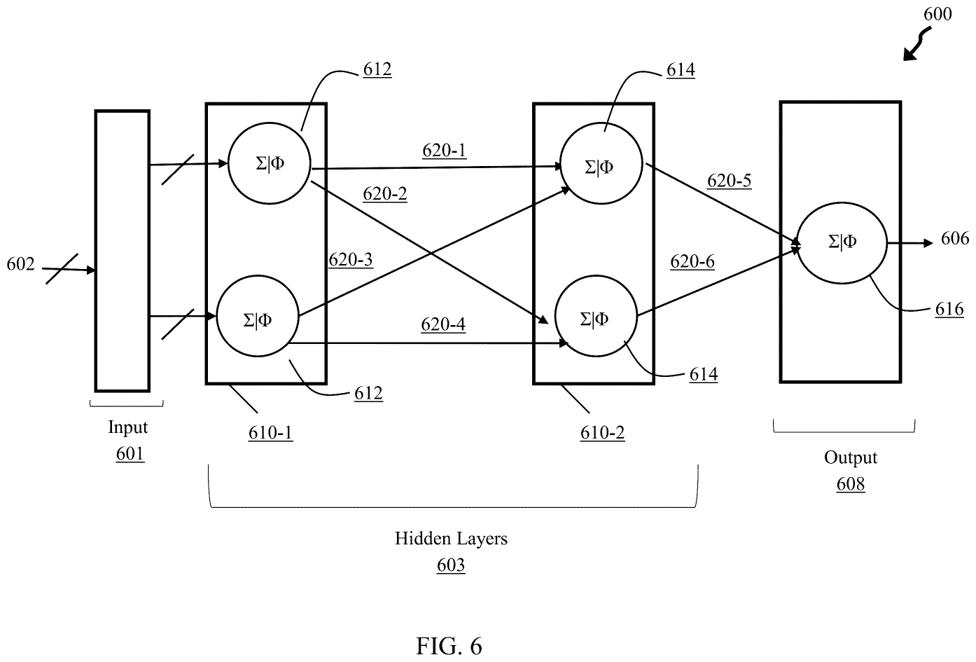

The machine learning circuit 111 may include computer-executable instructions structured to execute various machine learning models such as neural networks including convolutional neural networks, long short term memory networks, gated networks, deep neural networks), support vector machines (SVMs), random forests, and the like. The machine learning models in the machine learning circuit 111 may be trained to generate predicted resource availability of device(s) and/or network(s) in response to real time monitored resources of device(s) and/or network(s). The machine learning models may ingest the available resources (e.g., the monitored resources) at device(s) and/or network(s), extract features associated with the ingested data, and analyze the ingested data using a trained machine learning model to predict or otherwise determine a future resource usage of the device(s) and/or network(s). The machine learning models in the machine learning circuit 111 are discussed further herein with reference to FIGS. 5 and 6.

Referring first to FIG. 5, a block diagram of an example system 500 using supervised learning that may be used to determine future resource availability of device(s) and/or network(s) is shown, according to an example embodiment. Supervised learning is a method of training a machine learning model given input-output pairs. An input-output pair is an input with an associated known output (e.g., an expected output). Machine learning model 504 may be trained on known input-output pairs (e.g., historic resource availability at a particular device, historic resource availability of a group of devices, historic resource availability of a network, historic resource availability of a group of networks and associated resource availability at a time in the future of the device(s) and/or network(s)) such that the machine learning model 504 can learn how to predict known outputs given known inputs. Once a machine learning model 504 has learned how to predict known input-output pairs, the machine learning model 504 can operate on unknown inputs to predict an output. The machine learning circuit 111 may employ one or more machine learning models 504. To train the machine learning models to predict a future resource availability using supervised learning, training inputs 502 and corresponding actual outputs 510 may be manually provided to the machine learning model 504 (e.g., by one or more users entering in historic training inputs 502 and corresponding actual outputs 510), sensed/tracked automatically via one or more sensors (e.g., the camera of the input/output circuit 118) and provided to the machine learning model 504, and the like. For example, the input/output circuit 118 may capture images/video of resources at a first time (e.g., training inputs 502) and corresponding resources at a second time (e.g., actual outputs 510). In some embodiments, the input/output circuit 118 may classify the resources in the images/video using one or more image classification algorithms such that the machine learning model is provided quantities of resources at the first time and second time. Additionally or alternatively, the machine learning model 504 may receive the raw captured images/videos and employ one or more image recognition and/or object detection algorithms to determine quantities of the resources at the first time and the second time. Training inputs 502 may include historic resource availability, including particular resource availability at the device(s) and/or network(s) (e.g., historic denomination resource availability at a particular device, historic denomination resource availability of a group of devices, historic denomination resource availability of a network, historic denomination resource availability of a group of networks). For example, training inputs may include a quantity of a certain denomination of resources (e.g., the available number of $5 bills stored in a device at the end of each day, the available number of $10 bills stored in a device at the end of each hour, and the like). Actual outputs 510 may include actual future resource availability, including the particular resource availability (e.g., the number of available $5 bills stored in a device one day in the future, the number of available $10 bills stored in the device one hour in the future). The inputs 502 and corresponding actual outputs 510 may be stored in memory 116. For example, memory 116 of the governing institution computing system 110 may store historic resource availability and corresponding future resource availability. These inputs/outputs may be used to predict the resource availability (including the particular resource availability) of the device (or network) given the time of day, the weekday, the season, whether other particular resources are available, the physical location of the device, and the like.

Training the machine learning model 504 with data from other devices and/or networks allows the machine learning model 504 to learn, and benefit from, the interplay between the historic and future resource availability (including the availability of particular resources) of one or more devices. For example, a machine learning model 504 may be trained using historic resource availability of a device to predict resource availability of the device in the future. The machine learning model 504 may also be trained using historic resource availability of a device in addition to historic resource availability of a group of devices (e.g., resource availability of a network or a portion of a network) to predict resource availability of the device. Similarly, the machine learning model 504 may be trained using historic resource availability of a network (or a portion of a network) to predict resource availability of the network in the future. The machine learning model 504 may also be trained using historic resource availability of a network in addition to historic resource availability of a group of networks to predict resource availability of the network. Training the machine learning model 504 to predict a future resource availability at a device with resource availability of other devices may result in improved accuracy of the predicted resource availability of the device. For instance, a device may have less predicted resource availability if other devices have low resource availability. Accordingly, the consideration of the other devices and/or networks of a system may beneficially improve the accuracy of the predicted resource availability. Generally, machine learning models are configured to learn the dependencies between various inputs. Accordingly, by being trained using resource availability of other devices/networks, the machine learning model 504 learns the dependencies of the device (or network) as compared to the other devices (or networks), resulting in improved predictions (e.g., forecasting) over predictions that may be determined individually and/or independently.

Generally, the machine learning model 504 may use the training inputs 502 (e.g., historic resource availability, including particular resource availability) to predict outputs 506 (e.g., a predicted resource availability), by applying the current state of the machine learning model 504 to the training inputs 502. The comparator 508 may compare the predicted outputs 506 to the actual outputs 510 (e.g., a true resource availability determined by monitoring the resources of a device and/or network at a point in the future) to determine an amount of error or differences.

The error (represented by error signal 512) determined by the comparator 508 may be used to adjust the weights in the machine learning model 504 such that the machine learning model 504 changes (or learns) over time to generate a relatively accurate true resource availability using the input-output pairs. The machine learning model 504 may be trained using the backpropagation algorithm, for instance. The backpropagation algorithm operates by propagating the error signal 512. The error signal 512 may be calculated each iteration (e.g., each pair of training inputs 502 and associated actual outputs 510), batch, and/or epoch and propagated through all of the algorithmic weights in the machine learning model 504 such that the algorithmic weights adapt based on the amount of error. The error is minimized using a loss function. Non-limiting examples of loss functions may include the square error function, the room mean square error function, and/or the cross entropy error function.

The weighting coefficients of the machine learning model 504 may be tuned to reduce the amount of error thereby minimizing the differences between (or otherwise converging) the predicted output 506 and the actual output 510 such that the predicted resource availability is similar to the actual resource availability. The machine learning model 504 may be trained until the error determined at the comparator 508 is within a certain threshold (or a threshold number of batches, epochs, or iterations have been reached). The trained machine learning model 504 and associated weighting coefficients may subsequently be stored in memory 116 or other data repository (e.g., a database) such that the machine learning model 504 may be employed on unknown data (e.g., not training inputs 502). Once trained and validated, the machine learning model 504 may be employed during testing (or an inference phase). During testing, the machine learning model 504 may ingest unknown data to predict resource availability.

Referring next to FIG. 6, a block diagram of a simplified neural network model 600 that may be used to determine future resource availability of device(s) and/or network(s) is shown, according to an example embodiment. The neural network may be a machine learning model that is trained to predict resource availability based on a monitored resource availability (including particular resource availability) and/or historic resource availability of particular device(s) and/or network(s). The neural network model 600 may include a stack of distinct layers (vertically oriented) that transform a variable number of inputs 602 being ingested by an input layer 604, into an output 606 at the output layer 608.

The neural network model 600 may include a number of hidden layers 610 between the input layer 604 and output layer 608. Each hidden layer has a respective number of nodes (612, 614 and 616). In the neural network model 600, the first hidden layer 610-1 has nodes 412, and the second hidden layer 610-2 has nodes 614. The nodes 612 and 614 perform a particular computation and are interconnected to the nodes of adjacent layers (e.g., nodes 612 in the first hidden layer 610-1 are connected to nodes 614 in a second hidden layer 610-2, and nodes 614 in the second hidden layer 610-2 are connected to nodes 616 in the output layer 608). Each of the nodes (612, 614 and 616) sum up the values from adjacent nodes and apply an activation function, allowing the neural network model 600 to detect nonlinear patterns in the inputs 602. Each of the nodes (612, 614 and 616) are interconnected by weights 620-1, 620-2, 620-3, 620-4, 620-5, 620-6 (collectively referred to as weights 620). Weights 620 are tuned during training to adjust the strength of the node. The adjustment of the strength of the node facilitates the neural network's ability to predict an accurate output 606.

Referring back to FIG. 1, in some arrangements, the governing institution computing system 110 may access the machine learning circuit 111 using an API (e.g., from the API gateway 113). Beneficially, the governing institution computing system 110 may reduce the computing resources consumed by the governing institution by executing one or more operations using the API. For example, each machine learning model of the machine learning circuit 111 may have an associated API that may be used to call the machine learning model to reduce the burdens/computational resources of operating the machine learning models on the governing institution computing system 110. For example, APIs may be invoked such that the machine learning models are implemented in different environments such as on cloud environments.

The input/output circuit 118 includes communication circuitry for facilitating the exchange of data, values, messages, and the like between an input/output device and user of the governing institution computing system 110. In yet another embodiment, the input/output circuit 118 includes machine-readable media for facilitating the exchange of information between an input/output device and the user of the governing institution computing system 110. In still another embodiment, the input/output circuit 118 includes any combination of hardware components, communication circuitry, and machine-readable media. Hardware components can include a touchscreen, a keypad, microphone, camera, or buttons for receiving user inputs. Components of the input/output circuit 118 display text and/or graphics such that a user of the governing institution computing system 110 can configure the dashboard circuit 115 and/or the dashboard application 125. In one embodiment, the display is a touchscreen display that is capable of detecting user touches, e.g., to provide user inputs. In other embodiments, the user may generate user inputs via a mouse, keyboard, and the like.

The governing institution computing system 110 may also include an API gateway 113. The API gateway 113 may be configured to facilitate the transmission, receipt, authentication, data retrieval, and/or exchange of data between the components (e.g., applications, etc.) of the governing institution computing system 110, user device 121 and/or other third party devices.

Referring now to FIG. 2, an example GUI 200 illustrating resource availability of a device in a network is shown, according to an example embodiment. The dashboard application 125 may be instructed by dashboard circuit 115 to generate GUI 200 for display to the user via the user device 121. As shown, FIG. 2 illustrates a breakdown of the available resource denominations stored in a particular device at a particular location (e.g., a branch location associated with the governing institution). In alternate embodiments, GUI 200 may display a breakdown of the available resource denominations stored in a plurality of devices in the network and/or at a particular location. The GUI 200 may be accessed by a user assigned to the user device 121. The GUI 200 may also be accessed by a person having certain privileges to that allow access, such as a manager of the branch. As shown in 202, an available number of resource denominations in the ATM are illustrated as a bar graph such that the available resource denominations may be considered with respect to the storage capacity of each of the denominations of the particular device. However, other techniques of breaking down the available denominations may be displayed (e.g., pie charts). Further, each of the denominations may be color coded (or otherwise distinguished). In some implementations, an icon or other identifier may be displayed on GUI 200 indicating that a notification has been transmitted with respect to the particular device (e.g., that a user was alerted to take an action). Additionally or alternatively, denominations may be distinguished using color, luminosity, pattern, and the like, on GUI 200 in the event the denominations reach a threshold availability (e.g., fewer than ten of the particular denomination are available in the device). For example, when a particular resource denomination is running low (i.e., below a predefined threshold), the line on the line graph associated with that denomination may be displayed red. As shown, the storage capacity for each resource denomination is the same (e.g., 25), however in some embodiments, the storage capacity for each denomination may be different. For instance, the device may be configured to store more $5 bills and fewer $100 bills. In 204, the GUI 200 displays the total available cash of each resource denomination with respect to the total capacity of the particular device. Other visual representations may be displayed to the user to indicate the total available resource (e.g., currency/cash) of each resource denomination.

The GUI 200 may also display an average resource availability over a predefined amount of time. For instance, a user may select to view the average resource availability for a particular hour, day, a week, and the like based on historic average resource availability. For instance, the dashboard application 125 and/or dashboard circuit 115 may retrieve quantities of resources available in the resource repository device at various times in the day, on different days, etc., from memory 126 and/or memory 116. In an example, the input/output circuit 128 (described herein) may capture videos/photographs of resources stored in the resource repository device at various time of the day. Subsequently, quantities of available resources may be extracted from the captured videos/photographs by the input/output circuit 128 and stored in memory 126 and/or transmitted to memory 116 of the governing institution computing system. Other resource information, including a timestamp of the resource information, a characteristic of the resource (e.g., resource quantities such as a particular numbers of counted denominations), a device identifier of the device storing the resource (e.g., a serial number, a labeled number by an administrator), user information of a user currently assigned to the device, and the like, may be stored in memory 126 and/or memory 116 based on the captured videos/photographs and corresponding resource repository device. The GUI 200 may also display historic resource availability data (including historic average resource availability data and/or snapshots of resource availability at particular times) associated with particular devices and/or networks. For instance, the user may select to view resource denomination availability one hour ago, one day ago, one week ago, and the like. In some configurations, the GUI 200 may overlay average resource availability (or historic resource availability) and a current/monitored resource availability of the device.

In some configurations, the dashboard application 125 generates and displays various GUIs (or the same GUI with various degrees of information) to different users depending on the authorization/privileges of the user. The dashboard application 125 generates and displays the GUIs based on received user account information. For example, the user may log in to user device 121 with credentials and initialize the dashboard application 125. The various permissions/authorizations/privileges of each user are associated with that user (e.g., via a user account/profile). The different authorizations/privileges of the user are described herein, with reference to the authentication circuit 106. In response to the received user credentials and/or user account, the dashboard application 125 generates and displays a GUI. In a non-limiting example, the authentication circuit 106 authorizes (authenticates) the dashboard application 125 to display a first GUI to a teller, and a different GUI to a manager.

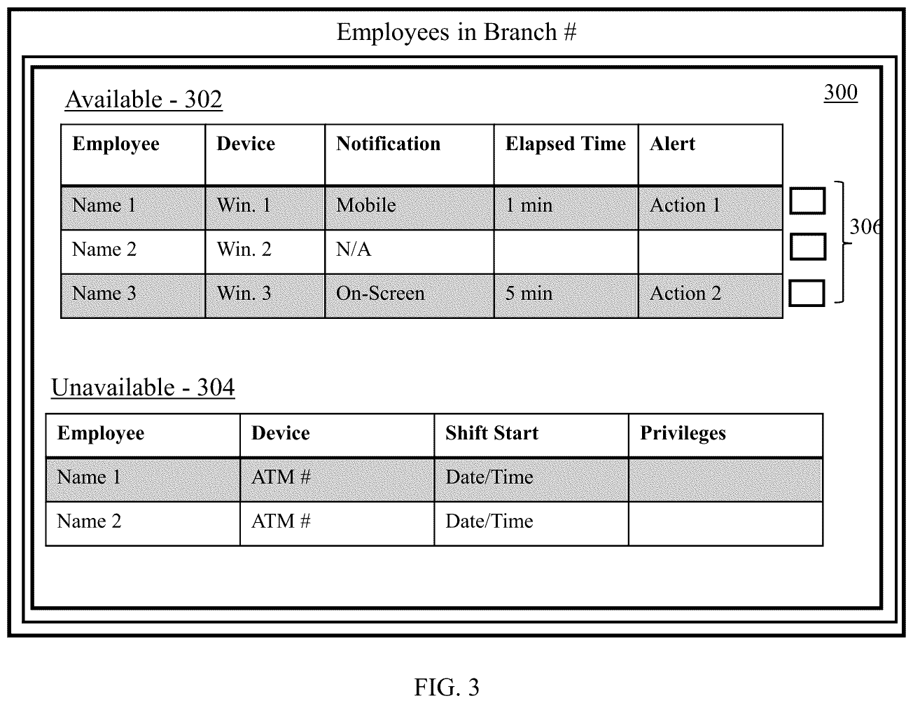

Referring now to FIG. 3, an example GUI 300 illustrating particular user resources is shown, according to an example embodiment. The dashboard application 125 may be instructed by dashboard circuit 115 to generate GUI 300 for display to the user via the user device 121. FIG. 3 describes an example GUI 300 that may be generated by the dashboard application 125 for a user responsible for managing a branch. As shown, the GUI 300 may display the available employees of the branch in 302. The available employees are the employees actively working (e.g., employees not on breaks, employees scheduled to work) and capable of performing an action (e.g., transporting resources). The GUI 300 may also display the name of the employee (and/or the employee account/employee identifier) and the device assigned to the employee (e.g., a teller window, an ATM, vault). The GUI 300 may further display whether the employee was notified to take an action based on the monitored resource availability (e.g., Action 1, Action 2). As described herein, the dashboard circuit 115 determines the action via rules circuit 103 and monitored data received from camera(s) at the user device 121/resource repository device, where the monitored data includes videos/photograph(s) of resource availability of the monitored resource repository device. The GUI 300 may display how the employee was notified (e.g., mobile device, work station device) and when the employee was notified. The GUI 300 may also display an interactive button 306. If a user interacts with interactive button 306, the dashboard application 125 may be configured to communicate with the dashboard circuit 115 to transmit (or re-transmit) a notification/alert to the user (e.g., a reminder to take the action, a confirmation that the action has been completed, etc.).

The GUI 300 may also display unavailable employees in 304. The unavailable employees may be inactive employees (e.g., off duty, on break, not schedule to work a particular day) that work in the particular branch. The GUI 300 may display which device the employee is commonly assigned to (or was most recently assigned to). The GUI 300 may also display the next shift start time (e.g., date/time) and any privileges/authorizations associated with that employee. For instance, a more senior employee may have privileges to work with higher sums of cash. Thus, the GUI 300 may be desirable to show who is available for resource movement/transferring and who has/has not already been notified to perform such a task.

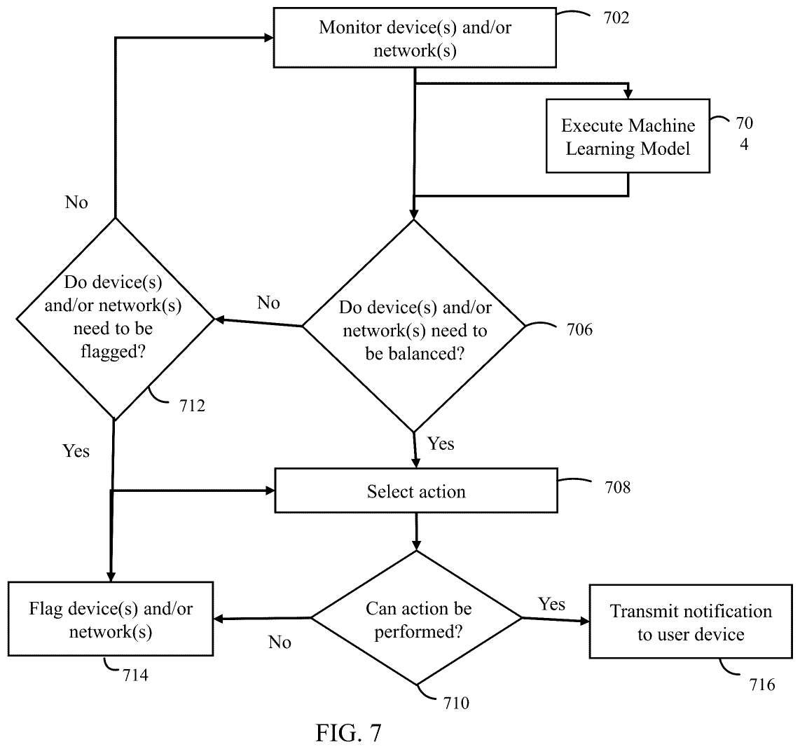

Referring now to FIG. 7, a flow diagram of method 700 for tracking and communicating resource availability is shown, according to an example embodiment. The governing institution described herein may manage resource repository devices storing resources in various network(s). In an illustrative example, the governing institution may be a bank, the networks of the governing institution system are bank branches, the devices of the networks of the governing institution are ATMs, cash drawers, cash bags, vaults, TCRs, and the like. Further, the resources of the governing institution may be considered physical currency, such as cash, in various denominations.

A common problem in any network is resource distribution. Tracking and communicating resource availability improves the resource distribution problem by optimizing the available resources in the network(s) and/or device(s) such that resources are distributed efficiently. Optimizing the distribution of available resources in the system improves the governing institution's operational costs (costs associated with transporting resources, costs associated with resource security, and administrative costs in making resource distribution decisions) and improves a customer experience. Optimizing the distribution of available resources in the system beneficially reduces redundant and/or extraneous costs associated with moving/transporting resources when the resources are required. For example, costs associated with transporting the same resources to the same destination multiple times are reduced. Moreover, customer experience is improved by providing optimal quantities of resources. In a particular example, in the governing institution context, the customers are people, entities, and the like, that interact with the governing institution. For example, if the governing institution is a retail entity, the customers of the governing institution may be people seeking to purchase a resource of the governing institution (e.g., clothes). If the retail location has clothes to purchase (e.g., resources), the customer experience will increase. That is, the customer experience was improved because resources were available. In a different example, if the governing institution is a financial institution, the customers of the governing institution may be account holders, where an account is an account maintained by the governing institution (a deposit account, a savings account, etc.). The customers of the bank may seek to withdraw and/or deposit cash resources into the system. If the customer cannot withdraw their desired funds (e.g., resources) from a resource repository (e.g., an ATM), the customer experience may be adversely affected. That is, the customer experience was adverse because resources were not available. Method 700 demonstrates a resources balancing tool that can facilitate internally balancing resources across multiple network(s) and/or device(s) by dynamically modifying monitored resources based on resource availability.

Technically and beneficially, the method 700 may reduce current or expected computational resources and network traffic by reducing the likelihood of resource and/or devices storing suboptimal levels of resources. The method 700 may reduce network traffic relating to device and/or network resource availability. For instance, network traffic may relate to identifying the resource repository device, communicating how to restock and/or resupply the resource repository device, scheduling transportation of resources for the resource repository devices, and the like. The method 700 proactively manages devices/networks in real time or near real time to reduce (or eliminate) communication that may be transmitted in the event that one or more devices/networks is in a predefined undesired condition (e.g., full and/or empty which may be defined as a critical state, non-operational state). The method 700 is used to monitor resources and communicate in real time or near real time actions that rebalance the resources in the device/network in the event one or more resource thresholds are satisfied. Operations of the method 700 may be conducted by the computing system 100 (e.g., governing institution computing system 110, user devices 121, non-integrated storage devices 141 and/or integrated storage devices 131).

In some embodiments method 700 may begin at 702 by monitoring resource repository devices and/or networks (e.g., monitoring an area). The resource repositories may be coupled to resource tracking devices (e.g., sensors such as weight sensors, cameras, etc.). Monitoring the resource repository devices and/or networks includes receiving, by the dashboard circuit 115, from the user devices 121 and/or integrated storage devices 131, captured video/pictures of resources contained within the resource repository devices and/or proximate to the resource repository devices using a camera (or other device or sensor). The dashboard circuit 115 monitors resource availability across the resource repositories based on information received from the plurality of resource tracking devices (e.g., sensors). Additionally or alternatively, the dashboard circuit 115 may receive analyzed data resulting from the captured videos/pictures of resources (e.g., quantities of resources detected from the captured video/pictures) from the user devices 121.

Monitoring the resource repository devices and/or networks includes continuously (or periodically) determining whether resources of a resource repository device and/or network have changed (e.g., been modified, updated, etc.). Resources are modified when, for example, a customer deposits cash in a device, a customer withdraws cash from a device, a network receives resources from a different network, and the like. Monitoring the resources includes determining information at the device responsible for capturing the video/photography data regarding the resource and/or resource repository device, such as a timestamp of the resource information, a timestamp of the last resources monitored, a characteristic of the resource (e.g., resource quantities such as a particular numbers of counted denominations), and the like. The dashboard circuit 115 may determine that a resource quantity for a resource repository device has been modified in response to (1) detecting movement at the resource repository device, (2) receiving an input from the user device 121 with updated resource information, and/or (3) comparing a first state of resource information of a resource repository device to a second state of resource information of the resource repository device.

In a first example, the dashboard circuit 115 determines that the resource information has been modified in response to motion detected from a motion detection sensor of the integrated storage device 131. For example, as described herein, a sensor's detection of movement (e.g., a user opening an integrated storage devices 131 or other resource repository device) may trigger the camera of the integrated storage devices 131 to capture the users activities such as the user depositing cash/withdrawing cash, monitoring the resources modified by the user.

In a second example, the user device 121 may transmit resource information manually (e.g., determined from non-integrated storage devices 141 by receiving, via the dashboard circuit 115, from the user device 121, an input with updated resource quantities). The user device 121 may also transmit resource information automatically determined (e.g., new currency counted via an integrated currency counting device) by an integrated storage device 131 based on the device 131 transmitting this information to the user device 121 (e.g., via a short-range wireless communication, such as NFC or Bluetooth). The integrated storage device 131 may also be configured to transmit resource information to the dashboard circuit 115 periodically and/or every time the resources are modified.

In a third example, the dashboard circuit 115 determines that the resource quantity has been modified in response to comparing states of resources quantities. The first state of the resource quantity for the resource repository device may include a quantity of particular resources at a first point in time. The second state of the resource quantity for the resource repository device may include a second quantity of the particular resource at a second point in time. The resources are modified when the first state of the resource quantity at the first point in time is different from the second state of the resource quantity at the second point in time. For example, at 1 pm, there are five $20 bills, and at 1:30 pm, there is one $20 bill. Accordingly, the resources in the resource depository device were modified. The dashboard application 125 may transmit the updated resource information (e.g., the difference between the first state and the second state of resource characteristics, the second state of the resource characteristic, the captured video/pictures in response to the detected movement at the resource repository device) to the dashboard circuit 115.

In some embodiments, every or nearly every time a resource is modified, the corresponding resource information is transmitted to the dashboard circuit 115. For instance, if a customer withdrew two $10 bills from an integrated storage device 131, the integrated storage device 131 may transmit the total number of available remaining $10 bills stored in the integrated storage device 131. In other embodiments, every or nearly every time a resource is modified, resource information regarding the modification such as the resource information at the first point in time (e.g., the first state), the resource information at the second point in time (e.g., the second state), the difference between the resource information in the first state and the second state, timestamps of the resource information at the first point in time/second point in time, characteristics of the resource, the unique identifier of the non-integrated storage device 141, integrated storage device 131, and/or user device 121 associated with the resource modification, the unique identifier of the integrated storage device 131 and/or user device associated with capturing the resource information, and the like, may be transmitted to the dashboard circuit 115. For instance, if a customer withdrew two $10 bills from an integrated device, the integrated storage device 131 may transmit a total number of available remaining resources stored in the integrated storage device 131 (e.g., the total number of available $100 bills, the total number of available $20 bills, and the like). In other implementations, the dashboard circuit 115 may continuously query user devices 121 and/or integrated storage devices 131 for updated resource information. The dashboard circuit 115 may query the user device and/or integrated storage devices 131 or each network, and/or a group of networks. The dashboard circuit 115 may also transmit the monitored resource information to memory 116 to be stored (e.g., to calculate average resource usage, to retrain the machine learning models).

In some embodiments, the input/output circuit responsible for capturing the raw video/photography data transforms the captured video/photography data into quantities of resources (e.g., a number of monitored resources available at the device) using object detection algorithm(s), object classification algorithm(s), and/or other image processing techniques. In some embodiments, the dashboard circuit 115 receives the raw video/photography data and transforms the received video/photography data into quantities of resources (e.g., a number of monitored resources available at the device) using object detection algorithm(s), object classification algorithm(s), and/or other image processing techniques.

In response to receiving monitored resource information at the dashboard circuit 115, the machine learning circuit 111 may execute a trained machine learning model at process 704. The trained machine learning model may ingest the monitored resource information and predict a future resource availability. The machine learning model may forecast the resource availability the same amount into the future that the machine learning model was trained to predict resource availability. That is, if the machine learning model was trained to predict resource availability an hour into the future, then the predicted resource availability forecasted by the machine learning model will be the resource availability an hour into the future. If the machine learning model receives a particular resource type, the machine learning model may forecast the particular available resource types in the future. For instance, if the machine learning model receives a number of available $5 bills, the machine learning model may forecast the number of available $5 bills in the future. In other implementations, if the machine learning model receives all resources in a device and/or network, the machine learning model may forecast all of the available resources in the device/network in the future.

At process 706, the dashboard circuit 115 determines whether to rebalance the resources identified as being stored in the devices/networks (the same devices/networks that provided the monitored resource information). Rebalancing the resources at process 706 can reduce the likelihood of the devices/networks associated with the monitored resource information reaching a critical state. For example, resources are rebalanced at the device/network before the device/network is empty/full of at least one resource (e.g., one denomination of cash). Resources of a device and/or network may be rebalanced as a result of satisfying one or more trigger conditions (e.g., rules, thresholds, etc.). As discussed herein, the rule circuit 103 may compare the monitored resource information and/or the predicted resource availability to one or more resource thresholds configured in one or more lookup tables. The resource thresholds may be determined from a user, device usage patterns, and/or governing institution policies of the governing institution computing system 110.

If the monitored resources and/or predicted resources do not satisfy the one or more thresholds, then at process 712, the dashboard circuit 115 may determine whether to set a flag regarding the device and/or network associated with the monitored resource information. A flagged device is a device that satisfies a flag threshold. The flag threshold may be an indicator of a device being in a critical state. The flag threshold may also be an indicator that a device is not yet in a critical state, but has a high likelihood of reaching a critical state based on satisfying one or more other thresholds. The dashboard circuit 115 may determine to set a flag regarding at least one of a network or resource repository device if the monitored resource availability and/or predicted resource availability satisfies one or more intermediary thresholds as indicated in the rule circuit 103. As described herein, the flagged device may be used by the dashboard circuit 115 when determining whether the device is capable of participating in resource recirculation.

That is, a resource of a flagged device may be exchanged with a resource of a previously flagged device. A device that has been flagged with a flag representing a low availability of a particular resource denomination may receive the particular resource denomination from a device that has previously been flagged with a flag representing a high availability of the particular denomination. There may be unique intermediary thresholds for each resource, each device, and/or each network. If the device(s) and/or network(s) associated with the monitored resources are not flagged, the dashboard circuit 115 may continue monitoring the device(s) and/or network(s) for subsequent resource modifications (or a next scheduled resource query of the device(s) and/or network(s) at 702).

If the dashboard circuit 115 determines to flag the device(s) and/or network(s) associated with the monitored resources (e.g., the monitored resource availability and/or predicted resource availability satisfies one or more intermediary thresholds as indicated by the rule circuit 103), then devices and/or network(s) are flagged by the dashboard circuit 115 at process 714. In some implementations, a flagged device may remain a flagged device until the flagged device is matched with an exchange device that may also be flagged. For example, a device flagged for satisfying an intermediary threshold indicating that the device has a low availability of a particular denomination may remain a flagged device until the flagged device is matched with a device flagged for satisfying an intermediary thresholds indicating that the device has a high availability of the particular denomination (e.g., reciprocally flagged devices, exchanging the resources of flagged devices).

In response to finding a match, the dashboard circuit 115 selects an action at process 708. In other implementations, if a flagged device is not matched with a reciprocally flagged device within a predefined duration of time, the dashboard circuit 115 may select an action at process 708 to resolve or attempt to resolve the resource distribution that resulted in the flagged device. For instance, a user assigned to a flagged device may be transmitted a notification/message via the user device 121 containing an action to restock one or more resources of the flagged device (e.g., restock $1 bills) if a timer/counter assigned to the flagged device exceeds a predefined duration of time (e.g., timer).

If, at process 706, the dashboard circuit 115 determines to balance the resources of a device and/or network based on one or more thresholds being satisfied, then the rule circuit 103 selects an action corresponding to the satisfied threshold at process 708. Actions selected by the dashboard circuit 115 include restocking an amount of resources stored in the resource repository, restocking a particular resource stored in the resource repository, removing an amount of resources stored in the resource repository, and/or removing a particular resource stored in the resource repository. The dashboard circuit 115 may also select an action in response to the dashboard circuit 115 matching a flagged device with a reciprocally flagged device, and/or an expired duration of time associated with a flagged device. For example, the action mapped to matching reciprocally flagged devices may include instructing the user to transfer the resources from the reciprocally flagged devices. For instance, the dashboard circuit 115 may generate instructions (provided via a notification of the dashboard application 125) for a user to transfer the resources in excess of the threshold of the device with a high number of resources to the device with the corresponding low number of resources. The rule circuit 103 may also map an action to one or more thresholds using a lookup table. For example, a user assigned to a device that has a number of available $20 bills below a threshold will be transmitted a message/alert including an action to restock the $20 bills of that device.

In addition to selecting an action, the dashboard circuit 115 identifies one or more users capable of implementing/performing the action. The dashboard circuit 115 identifies the one or more users based on stored characteristics of the user (e.g., privileges/authorizations), an availability of the user (e.g., based on the user's schedule), a closest user (based on a location of the user determined by pinging the location of the user device 121 associated with the user), and/or an urgency of performing the action (e.g., a required timing for transferring the first resource to the second resource repository). The dashboard circuit 115 may determine the urgency of performing the action based on the monitored resources and the one or more thresholds. For example, the dashboard circuit 115 determines a high urgency of performing the action if the monitored resource is empty (e.g., a user withdrew all of one or more resources from the resource repository device) and/or the monitored resource is full (e.g., the user filled up the storage of one or more resources in the resource repository device). The dashboard circuit 115 determines that the monitored resource is empty/full based on comparing the monitored resource to a threshold (e.g., an empty threshold or a max capacity of resources for the particular resource repository device threshold). A user is capable of implementing/performing the action if the user is authorized to perform the action. The dashboard circuit 115 identifies users authorized to perform the action based on the user privileges/permissions associated with the user account. In a non-limiting example, the rule circuit 103 maps all users as users capable of transporting a low quantity of resources from one device to another device. That is, when the dashboard circuit 115 selects an action that involves transporting a low quantity of resources (e.g., resource below a threshold level), the dashboard circuit 115 identifies all users as users capable of performing that action. In contrast, the rule circuit 103 maps select user as users capable of transporting high quantities of resources from one device to another device. The users capable of transporting high quantities of resources are identified using one or more data fields of the user account. Accordingly, when the dashboard circuit 115 selects an action that involves transporting high quantities of resources (e.g., resources above a threshold level), the dashboard circuit 115 identifies only the users authorized to transport high quantities of resources as users capable of performing the action. Users are selected by the dashboard circuit 115 as capable of implementing an action, based on the mapping of the rule circuit 103, the quantity of the resources transported, the device being locked/unlocked, the branch location, and the like.

At 708, before the selected action is transmitted to a user device via a message/notification, the dashboard circuit 115 may determine whether the action can be performed. The dashboard circuit 115 may determine that an action cannot or likely cannot be performed based on one or more constraints (e.g., user constraints, device constraints, etc.). Constraints may be based on a schedule (e.g., a computerized schedule) specific to users and/or devices and/or networks. The schedule may include information regarding an hours of operation of a network (e.g., a branch), an hours of operation of a resource repository device, a particular user's work schedule assigned to the resource repository device, and so on. As described above, the dashboard circuit 115 may determine that a user is available by, for example, monitoring a user's location information from the user device 121, analyzing a computer schedule such as accessing an Outlook schedule, and so on. Additionally and if certain users are proximate to the resource repository device scheduled for a transfer, the governing institution computing system 110 may determine which user(s) have the appropriate privileges for partaking in resource transfers/movements given the resource amount, location, device, etc. Thus, constraints may be employed that limit access to particular resource repository devices and/or networks.

In the event the action cannot be performed (e.g., based on the constraints), the device may be flagged at 714. In some embodiments, the dashboard circuit 115 may periodically re-evaluate the constraints at 710 to determine whether the constraints still apply. For example, the dashboard circuit 115 may flag a device in response to a user being unavailable (e.g., on a break). After re-evaluating the constraints, the dashboard circuit 115 may determine that the user is available (e.g., not on break). Accordingly, the dashboard circuit 115 can transmit a notification including an action to an available/authorized/privileged user.

In the event the action can be performed/implemented by the user, the dashboard circuit 115 may transmit the message/notification including the action to the user device at process 716 such that the user receives the message/notification and performs the action. In some embodiments, before the message/notification is transmitted to the user device 121, the dashboard circuit 115 may request user credentials to be authenticated and verified via the authentication circuit 106. The message/notification may be transmitted to the dashboard application 125 at the user device. For example, the dashboard application 125 may activate lights, a speaker, pop-up a window display (e.g., a pop-up message), and the like, to attract the user's attention to the message/notification such that the user implements the action. In some embodiments, the user may indicate, using the GUI generated by the dashboard application 125, the completed action.

In addition to transmitting the message/notification (including the action) to the user device 121, the dashboard circuit 115 may facilitate the authorized/privileged user in performing one or more actions. The dashboard circuit 115 may facilitate the authorized/privileged user in performing one or more actions by unlocking (or locking) a resource repository device.

In one example, the dashboard circuit 115 may generate an access token in response to determining that the action can be performed (e.g., process 710). The access token may be a digital token assigned to a particular user/user device 121. The dashboard circuit 115 may assign the access token to the particular user/user device 121 in response to determining that the user is available/authorized to perform one or more actions. The access token provides access to a resource repository device (e.g., unlocking the resource repository device). The access token may be generated based on a particular resource repository device, a particular user, a particular user device 121, a current time, a time that the user is expected to access the resource repository device, and the like.

The dashboard circuit 115 transmits the access token to the user device 121 prior to, subsequent to, or contemporaneously with the message/notification to the user device 121. As the user and the user device 121 satisfy a proximity threshold (based on location information of the device 121 relative to the repository device as determined by the governing institution computing system 11), the user device 121 transmits the access token to an integrated storage device 131 (using Bluetooth, NFC, or another short-range wireless communication protocol). In some embodiments, the user may tap the user device 121 to the integrated storage device 131 to initiate the user device 121 transmitting the access token to the integrated storage device 131. The integrated storage device 131 receives the transmitted access token and verifies the access token. In some embodiments, the integrated storage device 131 verifies that the access token is a valid access token by checking valid access tokens stored in memory 136. The integrated storage device 131 may also verify the access token by transmitting the access token to the dashboard circuit 115 for verification. The integrated storage device 131 may remain locked until the integrated storage device 131 receives a verification from the dashboard circuit 115 validating the access token. In some embodiments, the access token may include instructions for a time-duration regarding an unlocking of the resource repository device such that the device remains unlocked for that time duration. The integrated storage device 131 may also verify the access token in response to receiving the same access token from the dashboard circuit 115. For instance, the dashboard circuit 115 may transmit the access token to the user device 121 and the integrated storage device 131 simultaneously, nearly simultaneously, or sequentially. In yet other embodiments, the user may place the user device 121 on the integrated storage device 131 to initiate the user device 121 transmitting the access token to the integrated storage device 131. In these embodiments, the access to the integrated storage device 131 may be revoked upon removing the user device 121 from the integrated storage device 131.

In some embodiments, the access token may include instructions (e.g., logic, etc.) that define a removal characteristic. In this regard and after the dashboard circuit 115 transmits the access token to the user device 121 and after the user device 121 transmits the access token to the integrated storage device, the instructions cause the access token to be removed or deleted from the user device 121. This feature adds security by preventing repeated uses with the access token, and frees up memory in the user device 121. Moreover, this enables future access tokens to be received by the user device 121 without or substantially without a risk that wrong access tokens are transmitted to integrated storage device 131.

In some embodiments, the dashboard circuit 115 may initiate a timer after transmitting the access token to the user device 121. Additionally or alternatively, the integrated storage device and/or user device 121 may initiate a timer after receiving the access token from the dashboard circuit. In response to the expiration of the timer, the access token may become an invalid access token. The invalid access token will not unlock the resource repository devices.

As another example embodiment, in response to determining that the action can be performed (e.g., process 710), the dashboard circuit 115 may transmit one or more access codes to the user device 121 associated with the authorized/available user to facilitate the user in performing the action. The access code(s) may be used to lock/unlock the resource repository device. The access code(s) may also be transmitted to the repository device for verification. The access codes may be stored in memory 116. For example, the dashboard circuit 115 transmits a first access code to the user device 121 such that the user is able to access a first resource repository device (e.g., withdraw resources), and the dashboard circuit 115 transmits a second access code to the user device 121 such that the user is able to access a second resource repository device (e.g., deposit resources). In some embodiments, the first access code is the same as the second access code. In some embodiments, the access code(s) may become invalid in response to the expiration of a timer at the user device 121, governing institution computing system 110, and/or integrated storage device 131. In operation, the access code may be keyed-into the integrated storage device which verifies the access code by comparing it to the received access code(s). If verified, the device is unlocked for the resources to be accessed and moved. Once verified, the access code may be removed or otherwise marked as invalid in the repository device by the processing circuit 132.

In addition to receiving the message/notification, the user device 121 may receive a resource summary (e.g., an indication of the availability of each type of resource) of the device and/or network in the form of a dashboard (e.g., FIG. 2). The dashboard application 125 may display/generate the dashboard when the message/notification is transmitted to the user device 121. For example, the dashboard application 125 may display the available resources in the resource repository device after the user performs the action (or in anticipation of the user performing the action). The dashboard application 125 may also display the dashboard to the user device 121 any time the user requests access to the dashboard via the user device 121 (if the user is authorized to view one or more screens of the dashboard). In some embodiments, a first set of authentication credentials are received by the authentication circuit 106 before the dashboard circuit 115 transmits the message/notification to the user device (e.g., a face biometric of the user associated with the user device 121) and a second set of authentication credentials are received by the authentication circuit to display the dashboard to the user device (e.g., biometric information, passcode, password, a secure passkey specific to the account, answer to a security question, etc.). Similarly, a first set of authentication credentials are received by the authentication circuit 106 before the dashboard circuit 115 transmits an access token to a resource repository device, and a second set of authentication credentials are received by the authentication circuit 106 before the dashboard circuit 115 transmits an access token to another resource repository device.

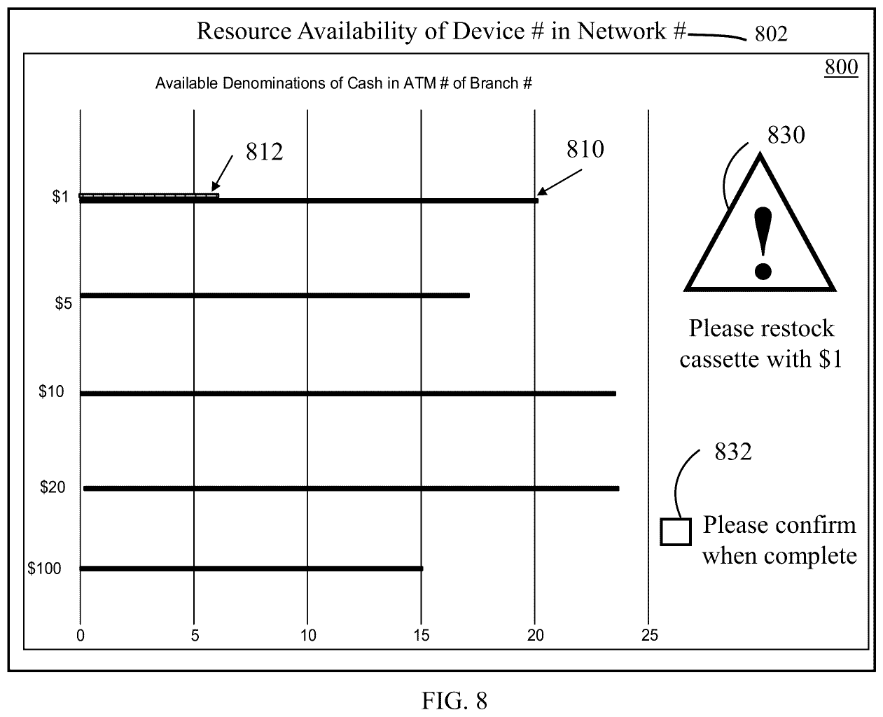

Referring now to FIG. 8, an example GUI 800 illustrating an example dashboard displaying resource availability is shown, according to an example embodiment. The dashboard application 125 receives instructions from dashboard circuit 115 to generate and GUI 800 for display to the user via the user device 121. The GUI 800 may be accessed by a user assigned to the user device 121. The GUI 800 may also be accessed by a person having certain privileges to that allow access, such as a manager of the branch. The dashboard circuit 115 may update the GUI 800 (e.g., from GUI 200 in FIG. 2) in response to transmitting a message/notification with an action to the user via the user device 121. The GUI 800 displays the monitored resource availability at 812 (e.g., the resource availability that triggers the dashboard circuit 115 selecting the action) and overlays the new resource availability 810 (e.g., the resource availability in response to the user completing the action). The dashboard circuit 115 may alert the user to the transmitted message/notification containing the action using colors, graphics, sounds, lights, and the like. For example, the dashboard circuit 115 may instruct the input/output circuit 128 of the user device 121 to make a sound, flash a light, vibrate, etc. As shown, GUI 800 includes icon 830. The icon 830 is displayed with words communicating the action. The action communicates to the user what the user should do to redistribute the resource availability. As described herein, the dashboard application 125 may be configured to receive a user input at 832, confirming the user's action upon the user's completion of the action. The dashboard application 125 may subsequently communicate the user's completed action to the dashboard circuit 115.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

1. A computer-implemented method, comprising:
coupling, by a governing institution computing system, to a plurality of resource tracking devices associated with a plurality resource repositories, wherein the plurality of resource tracking devices include at least one camera;
receiving, by the governing institution computing system and from at least one of the plurality of resource tracking devices, information associated with a resource, wherein the information includes audio, visual, or audiovisual data captured by the camera in response to a sensor detecting a motion at a first resource repository associated with the at least one of the plurality of resource tracking devices;
monitoring, by the governing institution computing system, resource availability of the resource across the plurality of resource repositories based at least in part on the information received from the at least one of the plurality of resource tracking devices, wherein monitoring the resource availability includes determining a modification in a resource amount at the first resource repository based on the captured audio, visual, or audiovisual data;
predicting, by the governing institution computing system, a resource amount in the first resource repository of the plurality of resource repositories using a trained machine learning model and the monitored resource availability across the plurality of resource repositories, wherein the trained machine learning model is trained to predict a future resource amount at a predetermined time in the future;
determining, by the governing institution computing system, that the predicted resource amount in the first resource repository satisfies a first threshold;
determining, by the governing institution computing system, that a resource amount in a second resource repository satisfies a second threshold, the second threshold different than the first threshold;
matching, by the governing institution computing system, the first resource repository and the second resource repository based on (i) the predicted resource amount in the first resource repository satisfying the first threshold and (ii) the resource amount in the second resource repository satisfying the second threshold;
identifying, by the governing institution computing system, a user from a plurality of users based on (i) a category of the resource repository, (ii) a characteristic of the resource, (iii) one or more permissions of the user associated with an authorization level of the user stored in a user profile, and (iv) an ability of the user to access the first resource repository and the second resource repository within the predetermined time based on a location of the user; and
transmitting, by the governing institution computing system, a message to the identified user to transfer a predetermined amount of the resource between the first resource repository and the second resource repository.

2. The computer-implemented method of claim 1, wherein the resource is physical currency, and wherein the first resource repository is at least one of an automated teller machine, a teller window, a cash bag, a cash drawer, a teller cash recycler, or a cassette.

3. The computer-implemented method of claim 1, further comprising:
determining, by the governing institution computing system, that a monitored resource amount in the first resource repository has changed based on information from a first resource tracking device associated with the first resource repository.

4. The computer-implemented method of claim 3, wherein the information includes at least one of weight information indicating a change in weight associated with the first resource repository, information regarding a machine-readable feature regarding a resource disposed in the first resource repository, or an indication of a change in a monitored area of the first resource repository.

5. The computer-implemented method of claim 1, further comprising:
comparing, by the governing institution computing system, the predicted resource amount in the first resource repository to an intermediary threshold; and
setting, by the governing institution computing system, a flag regarding the first resource repository responsive to the predicted resource amount in the first resource repository satisfying the intermediary threshold.

6. The computer-implemented method of claim 1, wherein the message includes a notification transmitted to a user device associated with the identified user of the plurality of users to move a first resource from the first resource repository to the second resource repository, the method further comprising:
syncing, by the governing institution computing system, computerized schedules of the plurality of users with the governing institution computing system;
identifying, by the governing institution computing system, the user based on stored characteristics of the user, a required timing for a transfer of the first resource to the second resource repository, a location of the user device, and an availability of the user based on the computerized schedule of the user; and
transmitting, by the governing institution computing system, a notification to a computing system associated with the second resource repository regarding the transfer of the first resource to the second resource repository and the identified user.

7. The computer-implemented method of claim 1, further comprising:
generating, by the governing institution computing system, a graphical user interface displayed on a user device, the graphical user interface instructing a user associated with the user device to perform at least one of restocking an amount of resources stored in the resource repository, restocking a particular resource stored in the first resource repository, removing an amount of resources stored in the first resource repository, or removing a particular resource stored in the first resource repository.

8. The computer-implemented method of claim 1, further comprising:
generating and displaying, by the governing institution computing system, a graphical user interface depicting monitored resource amounts across the plurality of resource repositories.

9. A system, comprising:
a processing circuit comprising a processor and a memory coupled to the processor, the memory containing instructions therein that, when executed by the processor, cause the processing circuit to:
receive resource information associated with a device;
predict future resource information using a trained machine learning model and the received resource information;
determine that the received resource information satisfies a resource threshold; and
transmit a notification to a user device comprising an action.

10. The system of claim 9, wherein the resource threshold is specific to the device.

11. The system of claim 9, wherein the instructions, when executed by the processor, further cause the processing circuit to select the action in response to mapping the resource threshold satisfied by the received resource information to the action.

12. The system of claim 9, wherein the instructions, when executed by the processor, further cause the processing circuit to synchronize computerized schedules of a plurality of users and transmit the notification to the user device based on the synchronizing of the computerized schedules of the plurality of users.

13. The system of claim 9, wherein the notification comprising the action comprises a pop-up message generated and provided via an application of the user device that provides an indication to perform at least one of restocking an amount of resources stored in the device, restocking a particular resource stored in the device, removing an amount of resources stored in the device, or removing a particular resource stored in the device.

14. The system of claim 9, wherein the instructions when executed by the processor, further cause the processing circuit to:
compare a predicted resource amount in the device to a threshold; and
set a flag regarding the device responsive to the predicted resource amount in the device satisfying the threshold.

15. The system of claim 9, wherein the resource is physical currency, and wherein the device is at least one of an automated teller machine, a teller window, a cash bag, a cash drawer, a teller cash recycler, or a cassette.

16. The system of claim 9, wherein the received resource information is based on monitoring resource availability across a plurality of devices.

17. The system of claim 16, wherein the resource information from the resource tracking device includes at least one of weight information indicating a change in weight associated with the device, information regarding a machine-readable feature regarding a resource disposed in the device, or an indication of a change in a monitored area of the device.

18. A computer-implemented method, comprising:
receiving, by a user device, a user credential;
authorizing, by the user device, access to an application running on the user device in response to the user credential matching an authorized user credential;
receiving, by the user device, instructions to display a graphical user interface subsequent to accessing the application, the graphical user interface displaying a resource availability across a plurality of resource repository devices;
displaying, by the user device, the graphical user interface to the user using a display on the user device, the graphical user interface instructing the user to transport a resource to a resource repository device of the plurality of resource repository devices;
acquiring, by the user device, information regarding the resource repository device subsequent to the instruction; and
transmitting, by the user device, a notification to a governing institution computing system associated with the resource repository device based on the acquired information.

19. The computer-implemented method of claim 18, further comprising:
receiving, by the user device, an access token configured to unlock the resource repository device of the plurality of resource repository devices; and
transmitting, by the user device, the access token to the resource repository device of the plurality of resource repository devices.

20. The computer-implemented method of claim 19, further comprising:
removing, by the user device, the access token from the user device subsequent to transferring the access token to the resource repository device.
